(19) United States
(12) Patent Application Publication
(10) Pub. No.: US 2006/0029050 A1
(43) Pub. Date: Feb. 9, 2006

(54) IP video telephone having integrated devices

(76) Inventors: John C. Harris, Rockwall, TX (US); Brad Stacy Shirley, Plano, TX (US); Guenter Hanfried Lehmann, Sachse, TX (US); Rene M. Cardenas, Dallas, TX (US); Michael R. Wilkinson, Richardson, TX (US); H. Michael Willey, Garland, TX (US); Jason A. Lickliter, Frisco, TX (US); CC Fichtner, Dallas, TX (US)

Correspondence Address: HOWISON & ARNOTT, L.L.P, P.O. BOX 741715, DALLAS, TX, 75374-1715, US

(21) Appl. No.: 11/194,044

(22) Filed: Jul. 29, 2005

Related U.S. Application Data
(60) Provisional application No. 60/600,546, filed on Aug. 11, 2004.
(60) Provisional application No. 60/600,573, filed on Aug. 11, 2004.
(60) Provisional application No. 60/600,299, filed on Aug. 10, 2004.
(60) Provisional application No. 60/600,740, filed on Aug. 11, 2004.
(60) Provisional application No. 60/600,286, filed on Aug. 10, 2004.
(60) Provisional application No. 60/600,285, filed on Aug. 10, 2004.
(60) Provisional application No. 60/600,265, filed on Aug. 10, 2004.
(60) Provisional application No. 60/600,287, filed on Aug. 10, 2004.
(60) Provisional application No. 60/599,969, filed on Aug. 9, 2004.
(60) Provisional application No. 60/599,967, filed on Aug. 9, 2004.
(60) Provisional application No. 60/600,098, filed on Aug. 9, 2004.
(60) Provisional application No. 60/599,970, filed on Aug. 9, 2004.
(60) Provisional application No. 60/600,011, filed on Aug. 9, 2004.
(60) Provisional application No. 11/184,036, filed on Aug. 5, 2004.
(60) Provisional application No. 60/600,574, filed on Aug. 11, 2004.
(60) Provisional application No. 60/600,865, filed on Aug. 12, 2004.
(60) Provisional application No. 60/641,684, filed on Jan. 5, 2005.
(60) Provisional application No. 60/641,883, filed on Jan. 5, 2005.
(60) Provisional application No. 60/641,326, filed on Jan. 4, 2005.
(60) Provisional application No. 60/641,328, filed on Jan. 4, 2005.

(51) Int. Cl. H04L 12/66

(52) U.S. Cl. 370/356

(57) ABSTRACT

An IP video telephone that comprises a video display for displaying video signals and a speaker for playing audio signals. A plurality of processor processes the audio and video signals received and transmitted by the IP video telephone. The processes are interconnected via an ethernet network. Integrated devices are incorporated within the IP video telephone and associated with at least one of the plurality of processors.

### RELATED INVENTIONS

This application claims priority from U.S. Provisional Application No. 60/600,546 filed Aug. 11, 2004 entitled “INTEGRATED RESOURCE MANAGEMENT AND A/V TELECOMMUNICATION DEVICE”; U.S. Provisional Application No. 60/600,573 filed Aug. 11, 2004 entitled “INTEGRATED DIGITAL JUKEBOX AND A/V TELECOMMUNICATION DEVICE”; U.S. Provisional Application No. 60/600,299 filed Aug. 10, 2004 entitled “INTEGRATED VOICE-OVER-INTERNET-PROTOCOL MULTIPLE TERMINAL ADAPTER AND A/V TELECOMMUNICATION DEVICE”; U.S. Provisional Application No. 60/600,1740 filed Aug. 11, 2004 entitled “INTEGRATED VIDEO CAMERA AND A/V TELECOMMUNICATION DEVICE”; U.S. Provisional Application No. 60/600,286 filed Aug. 10, 2004 entitled “INTEGRATED COUPON SERVER AND A/V TELECOMMUNICATIONS DEVICE”; U.S. Provisional Application No. 60/600,285 filed Aug. 10, 2004 entitled “INTEGRATED INTERNET RADIO RECEIVER AND A/V TELECOMMUNICATION DEVICE”; U.S. Provisional Application No. 60/600,265 filed Aug. 10, 2004 entitled “CALLER IDENTIFICATION FOR AN A/V TELECOMMUNICATION DEVICE”; U.S. Provisional Application No. 60/600,287 filed Aug. 10, 2004 entitled “DIGITAL VIDEO CALLER IDENTIFICATION ON AN A/V TELECOMMUNICATION DEVICE”; U.S. Provisional Application No. 60/599,969 filed Aug. 9, 2004 entitled “INTEGRATED DIGITAL CAMERA AND HANDSET FOR AN A/V TELECOMMUNICATION DEVICE”; U.S. Provisional Application No. 60/599,967 filed Aug. 9, 2004 entitled “INTERCHANGEABLE DISPLAY FOR AN A/V TELECOMMUNICATION DEVICE”; U.S. Provisional Application No. 60/600,098 filed Aug. 9, 2004 entitled “WIRELESS VIDEO CAMERA FOR AN A/V TELECOMMUNICATION DEVICE”; U.S. Provisional Application No. 60/599,970 filed Aug. 9, 2004 entitled “WIRELESS HANDSET FOR AN A/V TELECOMMUNICATION DEVICE”; U.S. Provisional Application No. 60/600,011 filed Aug. 9, 2004 entitled “VIDEO ANSWERING MESSAGE ON AN A/V TELECOMMUNICATION DEVICE”; U.S. Provisional Application No. 60/599,152 filed Aug. 5, 2004 entitled “ON-SCREEN INFORMATION MANAGEMENT SYSTEM FOR A/V TELECOMMUNICATIONS TERMINAL”; U.S. Provisional Application No. 60/592,793 filed Jul. 30, 2004 entitled “ALWAYS-ON AUDIO/VISUAL COMMUNICATION NETWORK DEVICE,”; U.S. Provisional Application No. 60/600,574 filed Aug. 11, 2004 entitled “INTEGRATED RADIO RECORDER AND A/V TELECOMMUNICATION DEVICE”; U.S. Provisional Application No. 60/600,865 filed Aug. 12, 2004 entitled “INTEGRATED INTERACTIVE ADVERTISING PROMOTIONS AND A/V TELECOMMUNICATIONS DEVICE”; U.S. Provisional Application No. 60/641,684 filed Jan. 5, 2005 entitled “INNER PROCESSOR COMMUNICATION IN A MULTIPROCESSOR DEVICE”; U.S. Provisional Application No. 60/641,883 filed Jan. 5, 2005 entitled “INNER PROCESSOR COMMUNICATION IN A VOICE OVER IP VIDEO TELEPHONY DEVICE”; U.S. Provisional Application No. 60/641,326 filed Jan. 4, 2005 entitled “METHOD FOR SYNCHRONIZATION OF AUDIO AND VIDEO PACKETS WITHIN AN IP VIDEO TELEPHONE”; and U.S. Provisional Application No. 60/641,328 filed Jan. 4, 2005 entitled “IP VIDEO TELEPHONE WITH POTS TELEPHONE CONNECTIVITY,” all of which are incorporated herein by reference.

### TECHNICAL FIELD OF THE INVENTION

The present invention relates to video telephony, and more particularly, to a voice over IP video telephone capable of operating over an IP network.

### BACKGROUND OF THE INVENTION

The combination of video and audio channels provides a unique platform for interpersonal communication. With the availability of broadband Internet network connections in the home, there is an opportunity to further methods of interaction between content providers and consumers.

An IP telephone is a telephone device that transmits voice over a network using data packets instead of circuit switch connections over voice only networks. An IP telephone refers to the transfer of voice over the Internet protocol (IP) of the TCP/IP protocol suite. Other voice over packet (VOP) standards exist for frame relay and ATM networks but many people use the terms voice over IP (VOIP) or IP telephone to mean voice over any packet network

IP telephones originally existed in the form of client software running on multi-media PCs for low cost PC to PC communications over the Internet. Quality of service (QOS) problems associated with the Internet and the PC platform itself resulted in poor voice quality due to excessive delay, variable delay, and network congestion resulting in lost packets, thus relegating VOIP primarily to hobby status. The QOS provided by the Internet continues to improve as the infrastructure is augmented with faster backbone links and switches to avoid congestion, higher access connections to the end users such as XDSL cut-down latency, and new protocols like RSVP and techniques like tag switching give priority to delay sensitive data such as voice and video. IP telephones include one wire systems for transmitting both voice and data. The data may comprise video data of the user of the IP phone in some embodiments. IP telephones provide better scalability as additional stations are added to the system, and the ability to mix and match IP telephones from different manufacturers.

IP telephones have several advantages over multimedia PCs with client software including lower latencies due to an embedded system implementation, a familiar user paradigm of using a telephone versus a PC enabled phone, greater reliability, and lower station costs where a PC is not required.

When considering IP telephones for home use, the network interface that is available is typically a DSL or cable broadband connection. Typically, IP telephones connect to a cable modem or DSL modem via a high speed interface such as Ethernet or universal serial bus (USB). There are also emerging home communication standards such as being presented by home RF, which provides wireless communication within the home. In this new residential environment, IP telephones will attach to the home LAN and have access to the data network and the PSTN via either a DSL or cable modem which communicates to DSLAM or cable system equipment.

A home voice overIP telephone including video capabilities would provide a platform for providing a number of different services and opportunities to the home user. A platform for implementing this service would be greatly desirable.

### SUMMARY OF THE INVENTION

The present invention disclosed and claimed herein, in one aspect thereof, comprises an IP video telephone including at least a display for displaying received video signals and a speaker for playing received audio signals. A plurality of processors within the IP video telephone process both the received and transmitted audio and video signals associated with the IP video telephone. The plurality of processors are interconnected via an ethernet network. Integrated devices incorporated within the IP video telephone are associated with at least one of a plurality of processors.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a household broadband information appliance;

FIG. 2 illustrates a handset for a household broadband information appliance;

FIG. 3 illustrates a block diagram of a household broadband information appliance;

FIG. 4 illustrates a block diagram of an IP video telephone;

FIG. 5 is a functional block diagram of the gateway of the IP video telephone;

FIG. 6 is a functional block diagram of the voice over IP processor of the IP video telephone;

FIG. 7 is a functional block diagram of the video processor of the IP video telephone;

FIG. 8 illustrates a network including an IP video telephone, a first server and a content provider;

FIG. 8a illustrates a wireless connection between an IP video telephone and an integrated device;

FIG. 8b illustrates an integrated digital camera;

FIG. 9 illustrates a wireless handset;

FIG. 10 illustrates an interchangeable video display;

FIGS. 11a-11c indicate the various manners in which processing components of the IP video telephone may be interconnected via an Ethernet network;

FIGS. 12a and 12b illustrate analog telephone connections to the IP video telephone;

FIG. 13 is an illustration of a call connection process using the IP video telephone;

FIG. 14 illustrates the manner in which delay may be created between video and audio packets when transmitted over an IP network;

FIG. 15 is a flow diagram illustrating one method for synchronizing audio and video packets;

FIG. 16 illustrates the method of inserting delays into the transmission of packets to achieve synchronization at a receiving end of audio and video packets;

FIG. 17 is an illustration of a home display displayed on the video screen of the IP video telephone;

FIG. 18 is an illustration of the calendar display on the display of the IP video telephone;

FIG. 19 is an illustration of the telephone display on the display of the IP video telephone;

FIG. 20 illustrates other display screens of the IP video telephone;

FIG. 21 illustrates inter unit communications between device processors;

FIG. 22 illustrates the software modules enabling communicating between a pair of IP video telephones;

FIG. 23 illustrates the manner that a stun module interacts with an IP video telephone;

FIG. 24 is a flow diagram illustrating a call connection using the software of FIG. 23;

FIG. 25 is a flow diagram illustrating a call receipt process;

FIG. 26 illustrates various software functionalities of an IP video telephone;

FIG. 27 is a flow diagram illustrating the operation of a video caller identification module;

FIG. 28 illustrates an operation of an audio/visual answering machine;

FIG. 29 illustrates a manner for reviewing stored messages in a audio/visual answering machine;

FIG. 30 illustrates a method of content management in the IP video telephone;

FIG. 31 illustrates an IP video telephone having an integrated incentive promotions function; and

FIG. 32 illustrates a method for an integrated interactive promotion.

### DETAILED DESCRIPTION OF THE INVENTION

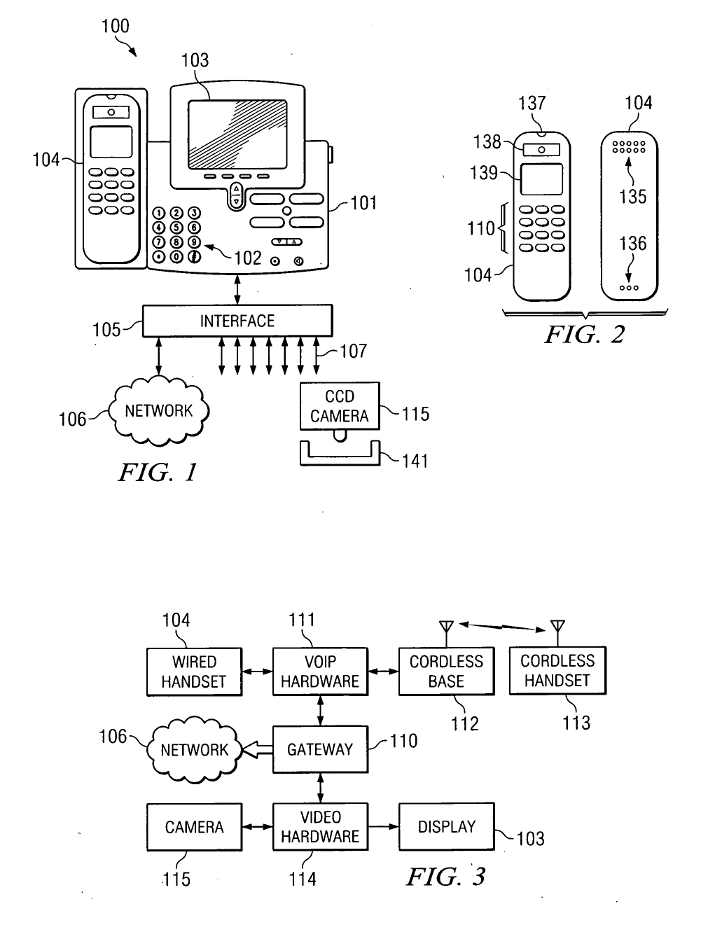

Referring now to the drawings, and more particularly to FIG. 1, there is illustrated a functional depiction of a broadband information appliance 100. The broadband information appliance 100 includes a base unit 101. The base unit 101 typically houses the processing circuits, memory storage, interfaces 105, manual inputs 102 and power connections. The base unit 101 may be attached to a display 103. The display 103 may be integral with the base unit 101. The display 103 may be an independent unit fixedly attached to the base unit 101. The display 103 may be interchangeably attached to the base unit 101 such that the display 103 may be easily exchanged for a different display 103. In a preferred embodiment, the broadband information appliance 100 comprises a video telephone. The video telephone provides the user with the ability to converse with an individual also having a video telephone while providing both audio and video outputs to each user of a video telephone.

The display of the IP video telephone 402 and the browser operating within the video processor 111 are typically left in a powered state to enable content to be received by the IP video telephone 402 at any point. In this manner, when the IP video telephone is not presently operating with supporting an audio/visual telephone call, the browser may be used to display content to an individual on the screen of the IP video telephone. This enables a host server interconnected with the IP video telephone 402 through a network such as the Internet to consistently provide advertising or other types of directed information on the display of the IP video telephone through the browser. This information may be determined in such a manner that the displayed information is of particular interest to the individual.

Base unit 101 may include manual inputs 102. Typically the manual inputs 102 for a video telephone include a standard telephone keypad with ten numeric buttons plus a “#” and “*” buttons. Manual inputs may further include any number of other button switches, thumb wheels, pointing devices or other appropriate manual input devices. A wide variety of functions and features may be controlled using the manual inputs 102. Manual inputs 102 may include navigation keys or a joy stick for up, down, right and left selections and programmable soft keys. Power and status LEDs may also be provided to display information to a user.

A base unit 102 may be connected to a handset 104. Handset 104 may be substantially a standard telephone handset including a microphone and speaker. Handset 104 may be directly connected to the base unit 101. A handset 104 directly connected to the base unit 101 may be called a “tethered” or “wired” handset. Handset 104 may also include a wireless transceiver, a wireless connection to the base unit 101 including (or connected to) a wireless transceiver. The wireless transceivers may be a 2.4 GHz transceiver or any other suitable wireless transceiver frequency. The wireless transceivers may be spread spectrum transceivers. A handset 104 wirelessly connected to the base unit may be called a wireless handset.

Base unit 101 is connected to an interface 105. Typically, interface 105 is integral with base unit 101. Interface 105 includes an interface for connection to a network 106 such as an IP network. The network 106 may comprise an open network such as the Internet. Interface 105 includes interface connections 101 for connecting the base unit 101 to a variety of peripherals or networks. Typically, the interface 105 will provide Ethernet ports, telephone handset and keypad support, video capture and display ports including NTSC composite input and output ports, S video ports, NTSC camera ports and LCD display ports. The interface 105 may include audio capture and reproduction ports, an external microphone port, an external speaker port, two audio line level inputs, and a hands-free speaker phone.

A digital video camera 115 is connected to the base unit 101. Typical digital video camera 115 comprises a CCD camera device. The digital video camera 115 may be integral with the base unit 101 or the display 103. An additional digital video camera 137 may be integral with the handset 104. A privacy shield 141 may be a cover provided to disable the digital video camera 137 by covering the lens of the digital video camera 137.

Referring now to FIG. 2, a more detailed description of the components that may be incorporated into the handset 104 is illustrated. The handset 104 typically includes a speaker 135 and a microphone 136 to provide standard audio communication. Handset 104 may include a digital video camera 137, typically at one end of the handset 104. A scanner 138 may be provided on the handset 104 to read machine readable codes or scan image data. An LCD display 139 may be provided on the handset 104 to allow the user to see the input from the digital video camera 137, or show video data being displayed on display 103 when the handset 104 is being used remotely from the base unit 101. The handset display 135 may also show alternate visual data. The handset 104 may further include manual inputs 140 to control the video camera 137, hand display 139 and scanner 138.

Referring now to FIG. 3, there is illustrated an overall functional block diagram of a basic broadband information appliance 100. A gateway 110 provides an interface to a network 106. In a preferred embodiment, the network is an IP network such as the Internet. The gateway 110 communicates with voice over Internet protocol (VOIP) hardware 111 and video hardware 114. The voice over IP hardware 111 provides all of the voice and audio functionalities for the broadband information appliance 100. The video hardware 114 provides the video capabilities to the broadband information appliance 100 such as streaming video of a speaker or display of a browser for browsing the IP network such as the Internet. The voice over IP hardware 111 may be directly connected to a wired handset 104 or may be connected to a cordless base unit 112 which provides wireless communications with a cordless handset 113. The video hardware 114 may be connected to a video camera 115 and a display 103.

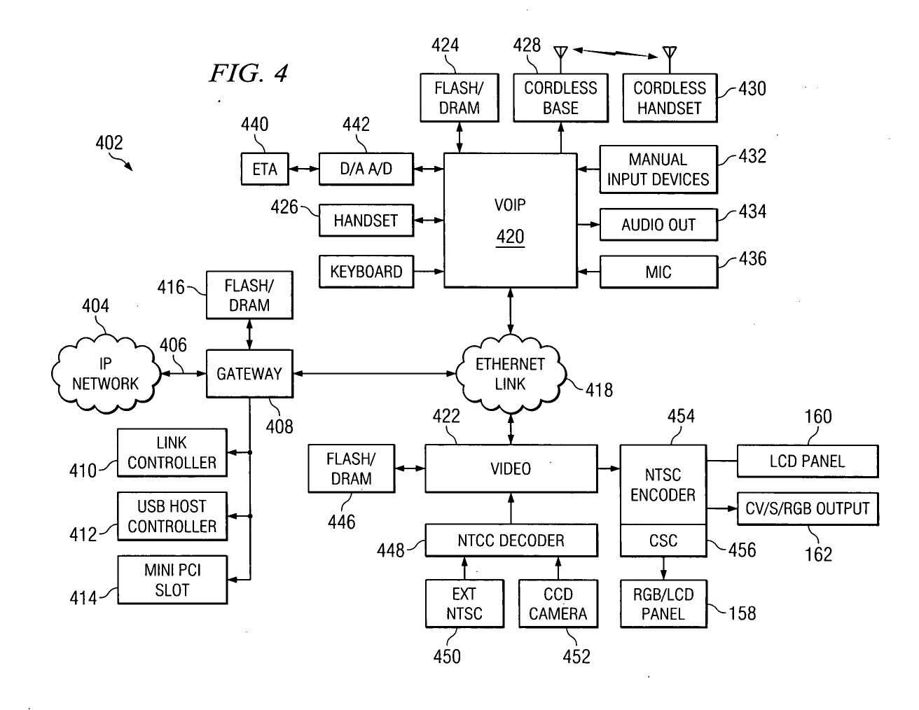

Referring now to FIG. 4, there is illustrated a detailed functional block diagram of an IP video telephone 402 that may more particularly comprise the broadband information appliance discussed above. The IP video telephone 402 is connected to an IP based network 404 through a connection 406. The interconnection 406 may be a wired connection such as a DSL connection or a cable connection through a DSL or cable modem, respectively. Alternatively, the interconnection 406 between the IP network 404 and the IP video phone 402 may comprise a wireless or satellite connection. The IP network 404 in the preferred embodiment comprises the Internet. However, any packet based network would be applicable to the following description. The IP video telephone 402 has its interface to the outside world and the IP network at a gateway processor 408. The gateway processor 408 provides communication with one or more networks 404. The gateway processor 408 typically acts as a master boot processor for the IP video telephone 402. The gateway processor 408 is typically an integrated, multiport PCI bridge system on a chip. In one embodiment, the gateway processor 408 comprises a Micrel KS 8695P processor. The KS 8695P integrates an ARM 922T CPU, a PCI bridge that can support up to three external PCI masters and a five port switch with integrated media access controllers and low power Ethernet PHYs. The PCI interface can be connected gluelessly to many PCI or card bus wireless LAN cards that support 802.11A/G/B. Those skilled in the art will recognize that other processors, chips or configurations could be used for the gateway processor 408.

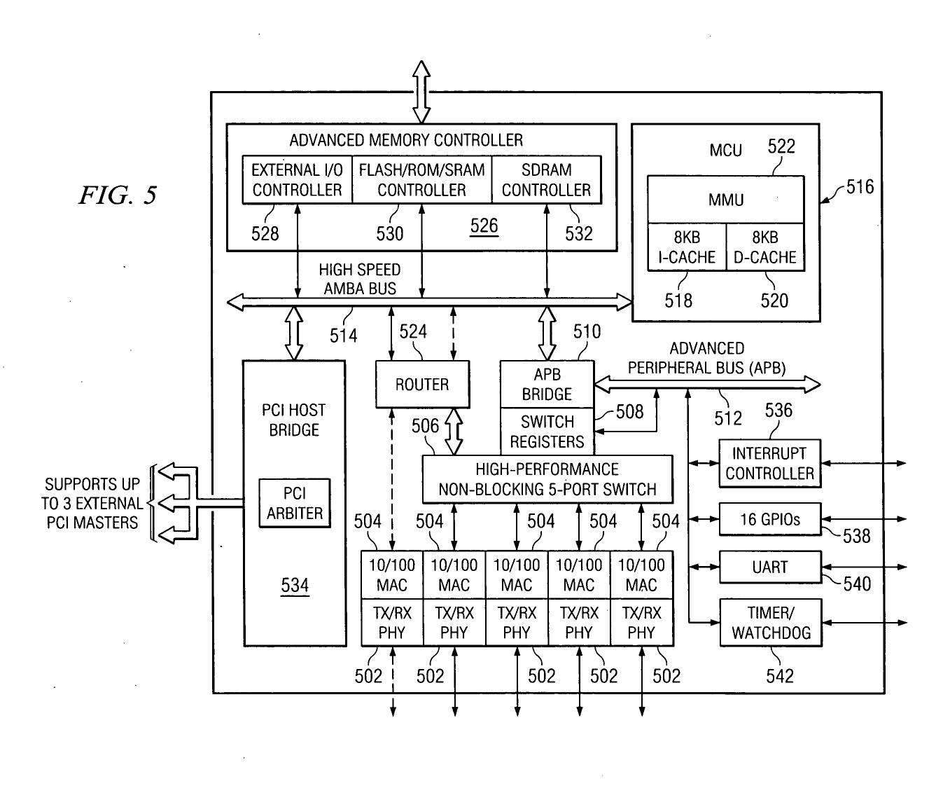

Referring now to FIG. 5, there is provided a functional block diagram of the gateway processor 408. The gateway processor 408 includes a plurality of transmit/receive PHY transceivers 502 enabling communications to and from the gateway processor 408. The transceivers 502 are mixed signal, low powered, fast Ethernet transceivers and have corresponding media access control units 504 associated therewith. A switching engine 506 moves data to and from the MACs 504. The switching engine 506 operates in a store and forward mode. Associated with the switch engine 506 are switch registers 508 and an APD bridge 510 for interconnecting the advanced peripheral bus (APB) 512 with the high speed AMBA bus 514. A microcontroller unit 516 controls operation of the gateway processor 408. The microcontroller unit 516 operates at 166 MHz and includes an 8 kilobyte I-cache 518 and an 8 kilobyte D-cache 520. A memory management unit 522 enables operation with Linex and WinCE®. A router 524 assists in the processing of packets transmitted by the gateway processor 408.

An advanced memory controller 526 includes an external input/output controller 528, a flash/ROM/SRAM controller 530 and an SDRAM controller 532. These controllers provide programmable 8/16/32 bit data and 22 bit address bus with up to 64 megabytes of total memory space for flash, ROM, SRAM, SDRAM and external peripherals. The PCI host bridge 534 supports three external PCI masters or guest mode and further a mini PCI and card bus peripheral. The PCI host bridge 534 supports a 33 MHz, 32 bit PCI interface. The gateway processor 408 further includes an interrupt controller 536 for generating interrupts in response to various interrupt conditions, 16 GPIOs for inputting and outputting data, a UART transceiver 540 and timer/watchdog circuitry 542 for timing various events.

Referring now back to FIG. 4, there are illustrated a link controller 410, USB controller 412 and mini PCI slot 414 connected to the gateway processor 408 via the PCI bridge 534. Likewise, the FLASH DRAM memory 416 is connected to the gateway processor 408 through the advanced memory controller 526. An Ethernet link 418 provides for interconnection between the gateway processor 408, a voice over IP processor 420 and a video processor 422. The voice over IP processor 420 is a communication processor providing audio, Codec and telephone management. In one embodiment, the VOIP processor 420 may comprise a teleology TNETV105 DSP.

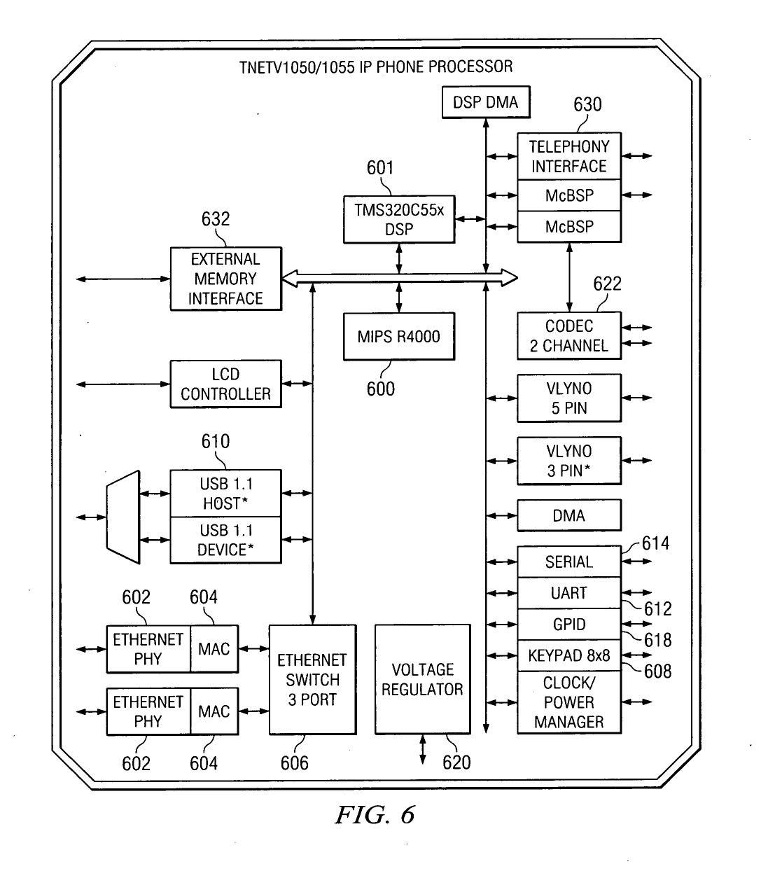

Referring now to FIG. 6, there is more fully illustrated one embodiment of the VOIP processor 408. Two 10/100 base T Ethernet PHY 602 and MAC 604 transceivers are included with an integrated layer to three port Ethernet switch 606. On-chip peripherals include an 8×8 keypad interface 608, a USB controller host 610, a UART serial interface 612, a programmable serial port 614 enabling serial port communications and a general purpose input/output interface 616. An integrated voltage regulator 620 provides for voltage regulation with respect to the VOIP processor 420. An integrated dual channel 16-bit voice codec integrates the coding/decoding functions necessary for IP phone applications and includes two analog-to-digital converters and two digital-to-analog converters. Other codec features include analog and digital side tone control, antialiasing filter, programmable gain options and programmable sampling rate. Other features of the VOIP processor 420 include analog-to-digital side tone control, filter, programmable gain options, programmable sampling rate, 8-bit speaker driver, microphone, and handset and headset interface 630.

The TNETV 1050 VOIP processor is a communications processor based on a MIPS 32 reduced instruction set computer (RISC) processor 600, along with a C55X digital signal processor (DSP) 601. The VOIP processor 420 has a rich peripheral set architect specifically for IP phone applications, which reduced the build materials costs, time and complexity associated with developing an IP phone. The RISC processor 600 supplies the overall system services and performs user interface, network management, protocol stack management, call processing and task scheduling functions. The DSP processor 601 provides real time voice processing functions such as echo cancellation, compression, PCM processing and tone generation/detection.

The external memory interface 632 supports two SDRAM chip selects providing 120 megabytes of memory space. The external memory interface 632 also supports three chip selects providing 16 megabytes each of RAM or ROM memory. Finally, the interface provides one chip select for providing a 32 megabyte flash memory.

Referring now back to FIG. 4, the VOIP processor 420 is connected to the flash/DRAM memory 424 through the external memory interface 632. The flash/DRAM memory 424 may comprise a flash memory, SDRAM or other suitable memory device. The VOIP processor 420 is also connected to a handset 426. The telephony interface 630 may also provide an interconnection for a cordless base 428 providing a wireless interconnection with a cordless handset 430. The voice over IP processor 420 may also be connected with a manual input device 432 to enable an individual to input information into the VOIP processor 420. Additionally, an audio out connection 434 provides for the ability to externally output audio information to the user of the IP video telephone 402. A microphone 436 enables the user to input audio information into the VOIP processor 420.

An embedded terminal adaptor 440 is interconnected with the VOIP processor 420 through a digital-to-analog and analog-to-digital interface 442. Information transmitted from the embedded terminal adaptor 504 is converted from analog into digital data by an analog-to-digital converter within the interface 442. Likewise, digital data coming from the VOIP processor 420 is converted into analog data for use by an analog telephone connected to the embedded terminal adaptor 440 by the interface 442. Information provided to the VOIP processor 420 by an analog telephone connected to the embedded terminal adaptor 440 is routed from the VOIP processor 420 to the gateway processor 408. The gateway processor 408 allows the data to be packetized and transmitted over the IP network 404 such that ultimately the data can be routed to another VOIP device connected to the IP network 404 or to an analog telephone connected to a PSTN network which is interconnected to the IP network 404.

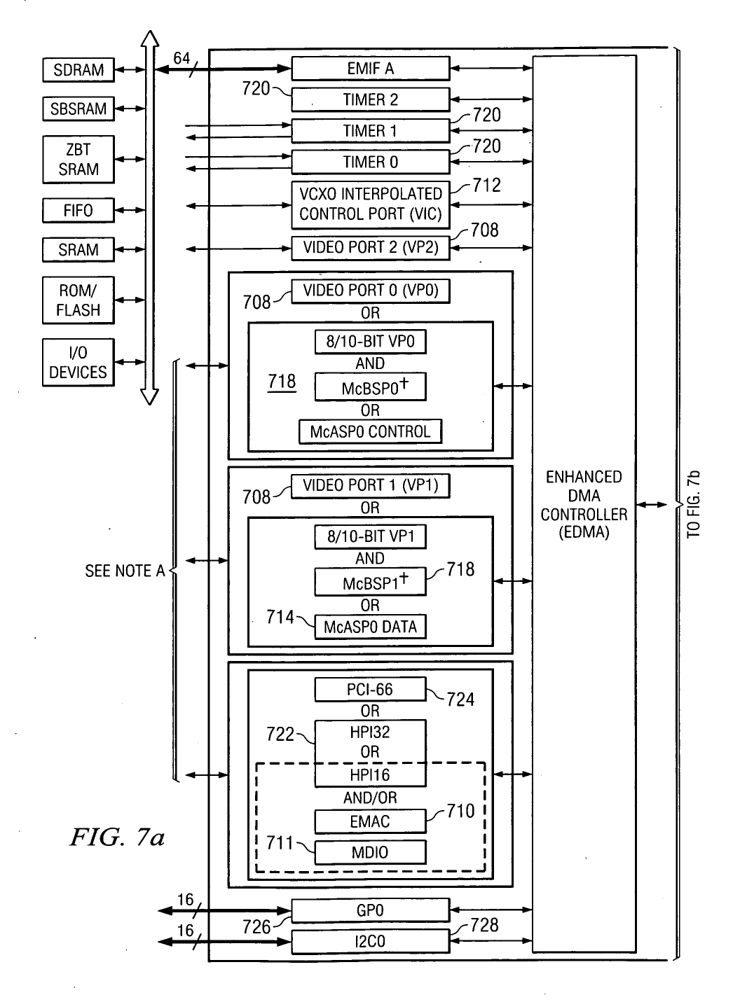

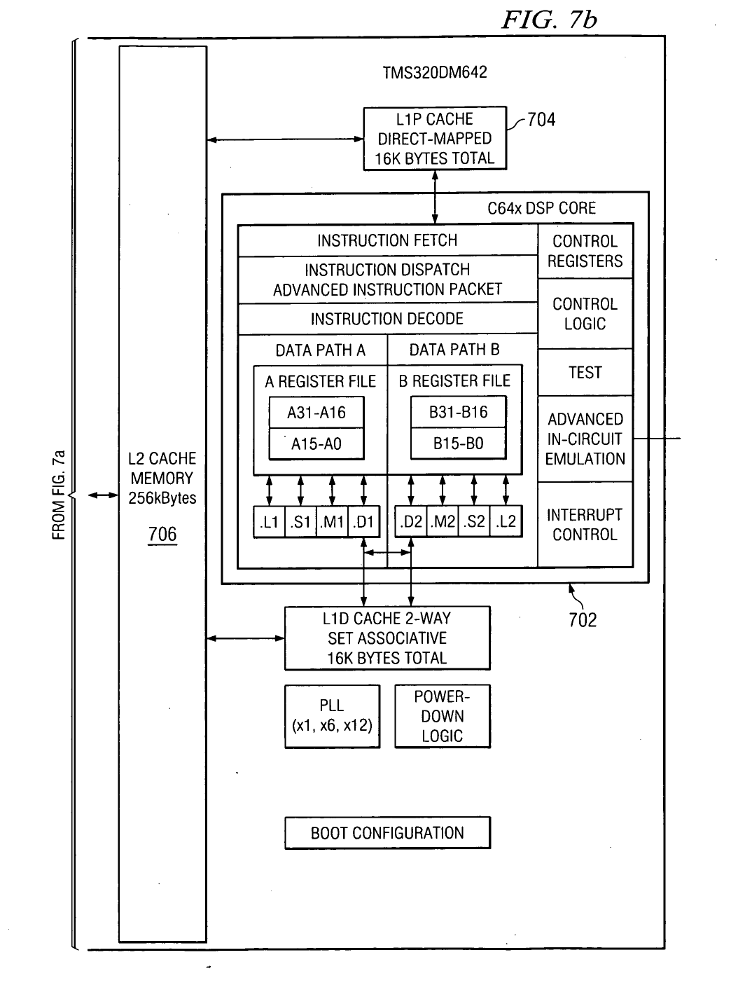

The video processor 422 is connected to the Ethernet link 418 to provide video capabilities for the IP video telephone 402. The video processor 422 includes a video Codec and LCD panel controller. The video processor 422 may in one embodiment comprise a TI TMS320DM642 digital signal processor. Referring now to FIG. 7, there is illustrated a functional block diagram of one embodiment of the video processor 422. The digital signal processor is based on the second generation high performance advance velociTI very long word instruction (VLIW) architecture. The digital signal processor may provide 4800 million instructions per second at a clock rate of 600 MHz. The DSP offers the flexibility of high speed controllers, and the numerical capability of array processors. A DSP core processor 702 has 64 general purpose registers of 32-bit word link and six arithmetic logic units. The DSP provides extensions in the eight functional units including new instructions to accelerate performance in video and imaging applications to extend parallelism. The DSP can produce four 32-bit multiply accumulates per cycle for a total of 2400 million MACs per second or eight 8-bit MACs per cycle for a total of 4800 million MACs. The DSP may have application specific hardware logic, on-chip memory and additional on-chip peripherals. The DSP typically uses a two level cache based architecture. A level one program cache 704 is a 128K bit direct mapped cache and a level one data cache is a 128-K bit direct mapped cache and a Level 1 data cache is a 128-K bit 2-way set-associative cache. A Level 2 memory cache 706 consists of a 2-M bit-memory space that is shared between program and data space. Level 2 memory can be configured as mapped memory. Those skilled in the art will recognize that other DSP processors may be implemented.

The video processor 422 includes three configurable video port peripherals 708 (VP0, VP1 and VP2). These video port peripherals provide a glueless interface to common video decoder and encoder devices. The DSP video port peripherals support multiple resolutions and video standards. The video ports peripherals are configurable and can support video capture and video display modes. Each video port may include two channels with a 5120 byte capture/display buffer that is split-able between the two channels. The DSP video ports include a capture port interfaced with a Philips decoder with integrated multiplexer for NTSC, S-video sources; a display port interfaced with Philips SAA7105 NTSC and S-video encoder and a third port dedicated to the LCD panel.

The peripheral set further includes a 10/100 Mb/s Ethernet MAC; a management data input/output 711; a VCXO interpolated control port 712; a multichannel buffered audio serial port 714; an inter-integrated circuit bus module; two multichannel buffered serial ports 718; three 32-bit general purpose timers 720; a user-configurable 16-bit or 32-bit host port interface 722; a peripheral component interconnect 724; a 16-bit general-purpose input/output port 726 with programmable interrupt/even generation modes; and a 16-bit glueless external memory interface 728 which is capable of interfacing to synchronous and asynchronous memories and peripherals.

The multichannel buffered audio serial port transmitter 714 is programmed to output multiple encoded data channels simultaneously with a single RAM containing the full implementation of user data and channel status field. The multichannel buffered audio serial port 714 also provides extensive error checking and error features, such as bad clock deterioration circuit for each high frequency master clock which verifies that the master clock is within a program frequency range.

The Ethernet media access controller 710 provides an efficient interface between the DSP core processor and the Ethernet network 418. The media access controller 710 supports both 10-base T and 100-base T in either have or full duplex with hardware flow control and quality of service support. The Ethernet MAC 710 makes use of a customer interface to the DSP core that allows efficient data transmission and reception.

The management data input/output (MDIO) module 711 continuously pulls all 32 MDIO addresses in order to enumerate all PHY devices in the system. Once a PHY candidate has been selected by the DSP, the MDIO module transparently monitors its link state by rating the rating the PHY status register. Link change events are stored in the MDIO module 711 and can optionally interrupt the DSP, allowing the DSP to pull the link status of the device without continuously performing costly MDIO accesses.

The VCXO interpolated control (VIC) 712 port provides a digital-to-analog conversion with resolution from 9-bits to up to 16-bits. The output of the VIC 712 is a single bit interpolated D/A output.

The I2C0 port 728 on the video processor 422 enables the DSP to easily control peripheral devices and communicate with a host processor. Additionally, the standard multichannel buffered serial port (MCBSP) 718 may be used to communicate with serial peripheral interface (SPI) mode peripheral devices.

The video processor 422 connects with a video memory 446. The video memory 446 may comprise a flash memory, SDRAM, or other suitable memory device. The video processor 422 also connects to a video decoder 448. The video decoder may comprise an NTSC decoder for decoding provided video data. The video decoder 448 receives video signals from an external NTSC source 450 or from a video camera 452. The video processor 422 is also connected with a video encoder 454 that may comprise an NTSC encoder. The video encoder 454 may be integral with a CSC 156 to provide video signals to a RGB/LCD panel 158. The video encoder 454 may also provide video signals to an LCD panel 163 and a CV/S/RGB output 162.

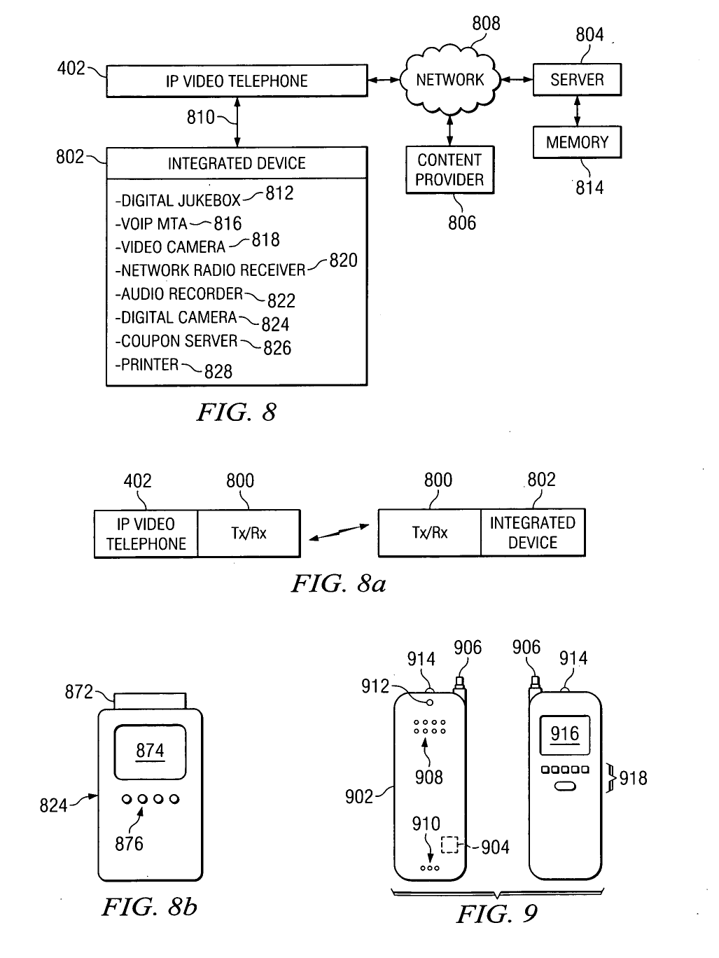

Referring now to FIG. 8, there is illustrated the interaction of the IP video telephone 402 having an integrated device 802, a host server 804 and a content provider 806 over a network 808, such as the Internet. The integrated device 802 is associated with the IP video telephone 402 via a communications link 810. The communications link 810 may comprise a wired link between the IP video telephone 402 and the integrated device 802, or alternatively, may consist of a wireless communications link between the IP video telephone 402 and the integrated device 802. In the case of a wireless communications link, the communications link 810 will require the use of a wireless transceiver within the IP video telephone 402 and a second wireless transceiver within the integrated device 802.

In one embodiment, the integrated device 802 may comprise a digital jukebox 812. The digital jukebox 812 receives music files from a content provider 806 through the network 808. The music files may comprise MP3 files, WMA files, wave files, or any other type of audio format which is supported by the digital jukebox 802 and the audio processor 422 of the IP video telephone 402. The user of the IP video telephone 402 may download desired music files from the content provider 806 using the browser functionalities discussed hereinabove of the IP video telephone 402 for storage in the digital jukebox 812. Alternatively, the content provider 806 may download or push various music files to the integrated digital jukebox 812 responsive to user established content interest within the IP video telephone 402. The user preferences may also be obtained from the server 804 which can data mine particular interest of the user of the IP video telephone 402 based upon browsing preferences. Thus, if the user of the IP video telephone had an interest in the music of David Sanborn, either through content selections established by the user or mined data information obtained by the host server 504, when a new album of David Sanborn came out, a music file of a song from the album or portions of multiple songs from the album may be downloaded to the digital jukebox for review by the user of the IP video telephone 402. Alternatively, the content provider 806 may provide a notification to the user of the IP video telephone 402 via the browser that a new David Sanborn album had come out. The user would then have the ability, utilizing the browser function 6026 and/or the digital jukebox 812, to download songs from the album for play by the user. The music files, in addition to being stored on the IP video telephone with the digital jukebox, may alternatively be stored within a memory 814 associated of the host server 804. The digital jukebox 812 processes the music files to play them over audio speakers associated with the IP video telephone 402 or processes streaming music files from the server 804 or content provider 806 for play. In addition to comprising a separate hardware device, the digital jukebox 812 may be implemented within the software of the IP video telephone 402. In this case, the digital jukebox 812 would be implemented within the operating software of the audio processor 422.

In a further embodiment, the integrated device 802 may comprise an integrated voice over IP multimedia terminal adapter 816 (VOIP MTA). The VOIP MTA 816 manages the connection of the IP video telephone 402 with a voice over IP telephony network. The VOIP MTA 816 enables the connecting of a POTS telephone to the video telephone 402, and the POTS telephone may then operate over the VOIP network. The VOIP MTA 816 implements media manipulation including sampling, encoding or decoding, encapsulation such as encryption or framing and call signaling protocols. In this way, the IP video telephone 402 may be used along with a POTS telephone within a user's home.

The VOIP MTA 816 is a voice over IP gateway which connects standard POTS telephones with an IP connection to enable Internet voice services. The VOIP MTA 816 may be used with existing wire line and wireless routers. For subscriber network environments where web searching via the browser, file transfers or other applications might harm the lay sensitive voice packets, the VOIP MTA 816 offers several quality of service mechanisms to prioritize VOIP traffic and protect call quality. The VOIP MTA 816 should be compatible with SIP based soft switch call management systems, and ensure rapid and secure provisioning through management options such as TFTP/HTPS auto-provisioning for large installations, an embedded web-based configuration utility and configuration back-up protection.

In a further embodiment, the integrated device 802 may include an integrated video camera 818. The integrated video camera 818 may comprise a CCD camera device but may comprise any type of video camera capable of creating a video display on the display monitor of the IP video telephone 402, or alternatively, is capable of creating video data in any type of streaming format that may be transmitted over the network 808. In one embodiment, the integrated video camera 818 may be integrated into the handset 104 of the IP video telephone 402. The video camera 818 may be integrated as a free-standing unit that is wirelessly connected to the IP video telephone 402 through link 812.

Referring now also to FIG. 8a, there is illustrated an embodiment of a manner for wirelessly interconnecting the IP video telephone 402 with the integrated device 802, such as the video camera 818. In this case, each of the IP video telephone 402 and the integrated device 802 include therewith a transceiver module 800 enabling wireless communication between each of the devices. The communication between the IP video telephone 402 and the integrated device 802 may comprise an infrared wireless connection, an RF connection, a blue tooth connection, or any other wireless transmission protocol that is capable of, in this case, transmitting video data between the units. Alternatively, the video camera 818 may be interconnected with the IP video telephone 402 via a wired connection. The video data that is collected by the video camera 818 may be displayed on the IP video telephone 402 or its associated display, or the data may also be stored within the memory of the IP video telephone. Alternatively, the video data may be transmitted to the host server 804 through the network 808 and stored within a memory 814 of the host server. The video data, either live or stored, within a memory of the IP video telephone 402 or the server 804, may be delivered to another IP video telephone over the network 808 for viewing on a display associated with that IP video telephone 402. In this manner, live video streaming feeds may be provided between IP video telephones 402 when the video data is being created in real time at the site associated with one of the IP video telephones or from a stored location.

The integrated device 802 may also comprise a network radio receiver 820. In response to an input or a sequence of inputs, such as an IP address, telephone number, etc., a request for connection to a particular radio media provider (content provider 806) is sent to the host server 804. The host server 804 accesses a database within memory 814 wherein said database identifies any necessary address association to establish connection to the particular content provider 806 that is indicated by the entered radio broadcast identifier. The radio broadcast content provider 806 sends radio content, such as a streaming audio signal, to the IP video telephone 402, and the streaming audio is converted to an analog signal to drive an audio speaker associated with the IP video telephone 402. The network radio receiver 820 may also store all of the pertinent information locally that is required to tune to a particular Internet radio provider through the network 808. In addition to tuning to particular radio providers, a user of the IP video telephone 402 can configure their network radio receiver 820 to tune to the Internet broadcast of their favorite local sports or music radio station that transmits locally from their area In addition to receiving Internet radio broadcasts over the IP network 808, the network radio receiver 820 may include the components necessary to receive standard AM/FM or satellite radio broadcasts.

The integrated device 802 may also comprise an integrated audio recorder 822 and associated memory. The IP video telephone 402 receives audio signals such as Internet radio transmitted over the network 808. The IP video telephone 402 may receive the Internet radio transmission by coordination between a host server 804 and the content provider 806 The IP video telephone 402 may be operable to begin audio recording of transmissions received over network 808 in response to a manual input sequence. The audio recording may be scheduled at the IP video telephone 402 such that specific transmissions are recorded based on the time, station, programming or other variables. The user may play the recorded audio recording on the IP video telephone 402 in response to a manual input sequence or at a scheduled time. The recording may be stored in memory off-site and would typically be managed by the host server 804 for delivery to the IP video telephone 402 upon request.

The audio recorder 822 is capable of recording any type of audio signal processed by the audio IP processor 422. The audio recorder 2504 may record Internet radio transmissions or voice transmissions received by the IP video telephone 402 in response to a manual input sequence. Alternatively, the audio recorder 802 may be programmed to schedule the recording of particular audio programs available through the IP network 2506 such that specific transmissions are recorded based upon time, station programming or other variables. The recorded audio information may be stored locally within the IP video telephone 402 or stored within the memory 814 of the host server 2510 associated with the IP video telephone 402. The user of the IP video telephone 402 may play the recorded audio in response to a manual input sequence on the IP video telephone 402 or at a selected scheduled time. The recorded audio signals may be stored in any desired audio format, such as MP3, WMA, WAV or other appropriate audio signal storage format.

The audio recorder 802 also includes the ability to create audio message files responsive to local audio inputs from the user of the IP video telephone 402. Thus, for example, it would be possible for a user to create an audio message that is stored on the audio recorder 802 that may be played by another user of the IP video telephone 402 at a later point, or alternatively, may provide an audio only message that can be played for calling parties to the IP video telephone 402. Alternatively, these stored audio recordings could be used to provide an audio identification of individuals who are calling the IP video telephone 402 based upon the caller identification signal associated with the calling party. Thus, for example, if John Smith were calling the IP video telephone 402, the user could record an audio file playing “John Smith” that is played whenever John Smith's telephone number is detected by the IP video telephone 402.

In another embodiment, the integrated device 802 may comprise a digital camera 824. The digital camera 824 includes a number of components such as those illustrated in FIG. 8b. These components would include a lens 872, a display 874 and manual inputs 876 enabling the user to take and manipulate pictures. The digital camera 824 may be capable oftaking and storing digital pictures in a variety of data formats. These data formats may include the JPEG format (joint photographic experts group format), the TIFF (tag image file format) or the RAW file format. The RAW file format does not comprise a standardized format, but is a category of similar file formats for which each camera manufacturer has their own version. A RAW file stores data exactly as it comes off of a sensor. For most digital cameras, this would comprise a single channel of pixels that is known as a bayer mosaic.

The digital camera 824 may be interconnected with the IP video telephone 402 through a wired communication link 810 which may permanently or removably connect the digital camera 824 to the IP digital telephone 402. Alternatively, the digital camera 824 may communicate with the IP video telephone 402 via a wireless communications link as illustrated in FIG. 8a As described previously, this wireless communication requires a transceiver device 902 associated with each of the IP video telephone 402 and the digital camera 824. Image data collected by the digital camera 824 and stored within a memory associated with the digital camera 824 or within a memory of the IP video telephone 402 can be transmitted over the network 808 and stored within the memory 814 of the server 804 or alternatively, may be transmitted to another IP video telephone for storage.

Using the digital camera 824, a user of an IP video telephone 402 stores pictures of various individuals within their IP video telephone or the memory 814 of the server 804 in order to provide a visual identification of an individual calling the IP video telephone 402. Thus, when the IP video telephone 402 receives an incoming call, if the caller identification associated with the incoming call is associated with a known individual that has a picture stored in a database the individual's picture is extracted from a database and displayed upon the display of the IP video telephone 402 providing the user with a visual indication of the calling party.

The integrated device 802 may comprise a coupon server 826. The coupon server 826 encodes, encrypts and authenticates coupon data files. The coupon server 826 may be used to validate discounts for various electronic transactions. The coupon server 826 provides the ability to print out various coupons using, for example, an integrated printer 828. The printer 828 prints coupons, tickets or other types of paper tokens. A coupon sent to the IP video telephone 402 from a content provider 806 is provided back to the content provider 806 or to another content provider 806 in order to obtain some type of discount or benefit from the coupon data file during an electronic commerce transaction occurring over the network 808. When the coupon data file is transmitted to the IP video telephone 402, it is communicated through the host server 804 or directly to the IP video telephone 402. If the coupon data file is transmitted through the host server 804, this event may be catalogued therein.

Referring now to FIG. 9, there is illustrated a wireless handset 902 used with the IP video telephone 402 rather than the tethered handset described hereinabove. The wireless handset 902 is communicably connected with the IP video telephone 402 by means of a transceiver 904 located within the wireless handset 902. The wireless transceiver 904 communicates with a similar transceiver located within the base station of the IP video telephone 402. The transceiver 904 of the wireless handset 902 communicates with the transceiver of the IP video telephone 402 using any known wireless communication protocol such as the blue tooth communications protocol, infrared communications protocol, RF communications protocol, or any other known protocol for enabling voice and packet data to be transmitted between the wireless handset 902 and the IP video telephone 402. An antenna 906 within the transceiver 904 is used to transmit and receive the wireless signals. The wireless handset 902 additionally includes a speaker 908 for playing audio signals from the IP video telephone 402 and a microphone 904 for generating audio signals responsive to user voice input. An optical scanner 912 and a digital or video camera 914 may be integral to the wireless handset 902 to enable the transmission of optically scanned data and digital picture or video data from the wireless handset to the wirelessly connected IP video telephone 402. A display 916 enables a user to view video packets transmitted from a received call. Additionally, manual input buttons 918 enable the user to control operation of the wireless handset 902 and all of the functionalities associated therewith. The wireless handset 902 provides a user of the IP video telephone with the ability to move freely about their home or business within a limited range of the wireless transceiver 904 while still being able to utilize the audio and video call capabilities provided by the IP video telephone 402.

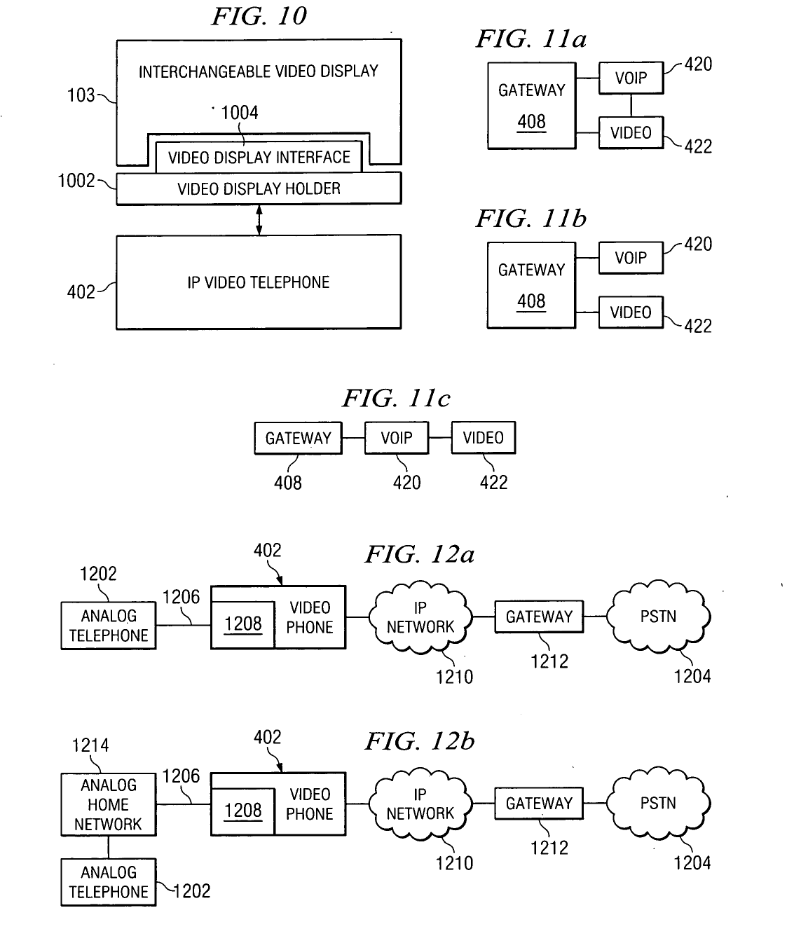

Referring now to FIG. 10, there is illustrated the use of an interchangeable video display enabling the use of multiple video displays 103 with the IP video telephone 402. In this case, the IP video telephone 402 includes integral therewith a video display holder 1002 for physically receiving and holding an interchangeable video display 103. The video display holder 1002 will be configured in such a manner that a number of interchangeable video displays 103 would fit within the video display holder. Integral with the video display holder 1002 is a video display interface 1002. The video display interface 1004 comprises the electrical and mechanical interface port for electrically and mechanically connecting the IP video telephone 402 with a video display 103 to enable signal transmissions therebetween. The video display interface 1004 comprises a standard interface that interfaces with most, if not all, available video displays 103. The video display interface 1004 interconnects with a matching interface on the interchangeable video display 103 via some type of cable connection between the interchangeable video display 103 and the IP video telephone 402 or, alternatively, each of these devices could include a wireless transceiver that enabled the transmission of video packets between the interchangeable video display 103 and the IP video telephone over the video display interface 1004. Additionally, the video display interface 1004 may be placed in such a manner such that when the interchangeable video display 103 is placed within the physical video display holder 1002, a port of the interchangeable video display 103 automatically plugs into the video display interface 1004 by the mere placement of the video display 103 in the video display holder 1002.

Referring now to FIGS. 11a-11c, there is more fully illustrated the flexibility provided by the use of a gateway processor 408, VOIP processor 420 and video processor 422 that are able to communicate via an Ethernet network on a same board. FIG. 11a illustrates a first configuration of the gateway processor 408, voice over IP processor 420 and video processor 422. Each of these processors are included upon a same device board within the IP video telephone. In this configuration, each of the processors has an Ethernet connection with each of the other processors. Thus, the gateway processor 408 may communicate directly with the voice over IP processor 420 and the video processor 422. Also, the voice over IP processor 420 may communicate with each of the gateway processor 408 and the video processor 422, and finally, the video processor 422 may communicate with each of the gateway processor 408 and voice over IP processor 420.

FIG. 11b illustrates a configuration wherein only the gateway processor 408 may communicate with each of the voice over IP processor 420 and the video processor 422. When the video processor wishes to converse with the voice over IP processor 420, it must do so through the gateway processor 408. Thus, IP packet messages are transmitted from the video processor 422 to the gateway processor 408, and the gateway processor 408 then forwards the IP packets to the voice over IP processor 420. Likewise, when the voice over IP processor 420 desires to communicate with the video processor 422, it must forward packets to the gateway processor 408 which then forwards the packets onward to the video processor 422. As can be seen, each of the voice over IP processor 420 and video processor 422 may communicate directly with the gateway processor 408.

Finally, FIG. 11c illustrates a chained configuration wherein the gateway processor 408 communicates only with the voice over IP processor 420. The voice over IP processor 420 can communicate with either of the gateway processor 408 and the video processor 422. The video processor 422 only communicates with the voice overIP processor 420. All packets transmitted from the gateway processor to the video processor must be transmitted through the voice over IP processor 420, and likewise, all packets transmitted from the video processor 422 to the gateway processor 408 must be routed through the voice over IP processor 420.

The use of processing devices on the same board having packet network communications functionalities associated therewith enables an ease of configuration and updating with respect to the IP video telephone board. In this configuration, any of the processing chips used for either the voice over IP processor 420, gateway processor 408 and video processor 422 may be upgraded to a different chip or component by merely implementing the new chip within the board design. The only requirement is that the newly implemented chip must have the ability to transceive over an Ethernet network. Since the processors within the IP telephone board are each designed to carry out their various functionalities and communicate with the outside world using IP packets via an IP network, the use of differing components for these processors does not adversely affect the operation of the IP video telephone board.

Referring now to FIGS. 12a and 12b, there are illustrated the manners in which an analog telephone may be both connected to the PSTN network 1204 through an IP video telephone 402. In this embodiment, the analog telephone 1202 connects with the IP video phone 402 through an analog connection 1206. The analog telephone 1202 is plugged into the IP video telephone 402 at an embedded terminal adaptor 1208. Embedded terminal adaptor 1208 enables the IP video telephone 402 to accept analog signals from the analog telephone 402 and convert them into digital IP packet data that may be used to transmit over the IP network 1210 to the PSTN network 1204. The IP network 1210 is connected to the PSTN network 1204 through a gateway 1212.

Referring now to FIG. 12b, there is illustrated an alternative embodiment wherein the analog telephone 1202, rather than being plugged directly into the IP video telephone 402, is plugged into an analog home network 1214. Rather than plugging the analog telephone 1202 directly into the embedded terminal adaptor 1208, the analog home network 1214 is plugged into the embedded terminal adaptor 1208. In this manner, analog telephones 1202 within a home may be plugged into the existing telephone jacks of the home since the analog home telephone network is no longer directly connected to the PSTN network 1204 but is instead connected to the IP video telephone 402. Signals generated by the analog telephone 1202 are transmitted over the analog home network 1214 to the IP video telephone 402 through the embedded terminal adaptor 1208. These signals are converted to IP packet signals and provided over the IP network 1210 to the public switched network 1204 or other IP video phones connected to the Internet.

When connected in the manners illustrated in FIGS. 12a and 12b, the analog telephone 1202 will operate as it normally does when connected with the PSTN network 1204. The connection to the PSTN network 1204 through the IP network 1210 via the IP video telephone 402 is seamless to the user of the analog telephone 402.

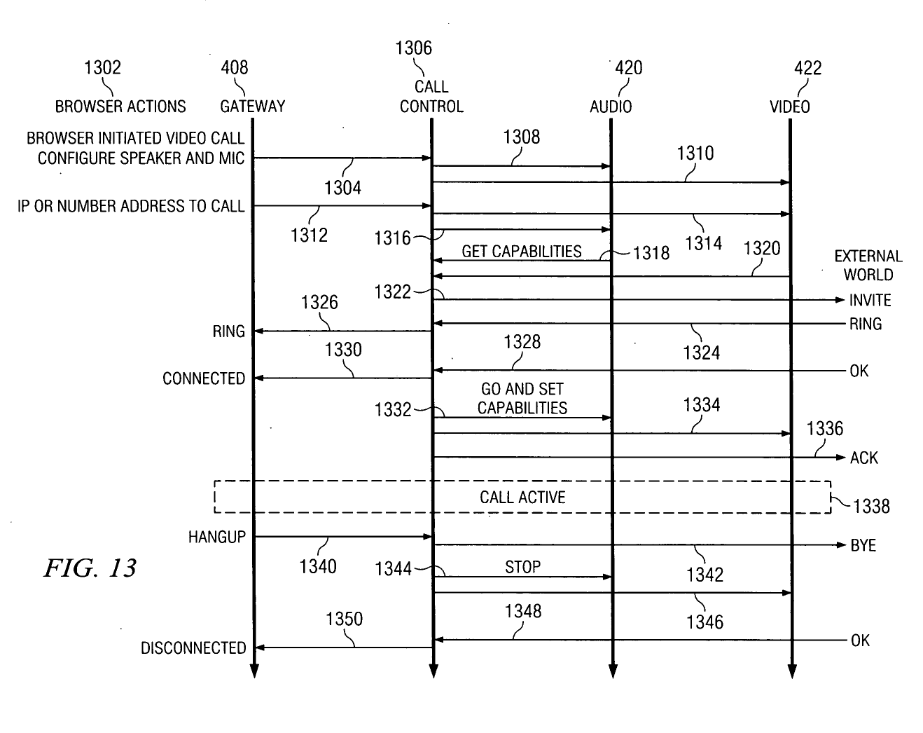

Referring now to FIG. 13, there is illustrated the process for providing a call connection and call disconnection using the IP video telephone of the present disclosure. Initially, a browser 1302 initiates a call by transmitting a message 1304 to call control 1306. The call control 1306 transmits a message 1308 to the audio processor 420 to configure the audio processor protocol. The call control 1306 also transmits a message 1310 to the video processor 422 to configure the video processor for operation. The gateway 408 provides the IP address or number address for the call at 1312. This information is provided to the video processor 422 at 1314 and to the audio processor 420 at 1316. The audio processor 420 provides the ability to provide audio support for the call at 1318, and the video processor 422 provides the capabilities for video processing for the call at 1320. The call control 1306 initiates the call to the external world at 1322.

A ring signal 1324 is provided from the external world back to the call control and the call control forwards the ring signal to the gateway processor and the call control 1300 forwards the ring signal to the gateway processor 408 at 1326. After the call is answered at the receiving end, an answer signal 1328 is provided from the external world to the call control 1306. The call control 1306 notifies the gateway 408 that the call is connected using a call connection signal 1330. The call controller 1306 notifies the audio processor 420 at 1332 that the call is connected and sets the capabilities for the call with the audio processor. The video processor 422 is notified at 1334 that the call is connected and sets the capabilities for the video processor 422. The call control 1306 transmits an acknowledge signal 1336 back to the external world to where the call has been answered. The call is supported by the IP video telephone during the time period 1338 for which the call is active.

Once the user has completed the call and hangs up the receiver of the IP video telephone, a hang-up signal 1340 is provided from the gateway 408 to call control 1306. The call control 1306 initiates a hang-up notification 1342 to the external world to the unit to which the IP video phone is connected. The call control 1306 initiates a stop signal 1344 to the audio processor 420 and a stop signal 1346 to the video processor 422 to indicate that the call has been disconnected. An acknowledgment 1348 is received from the external world at the call control 1306, and the call control notifies the gateway processor 408 that the call is disconnected at 1350.

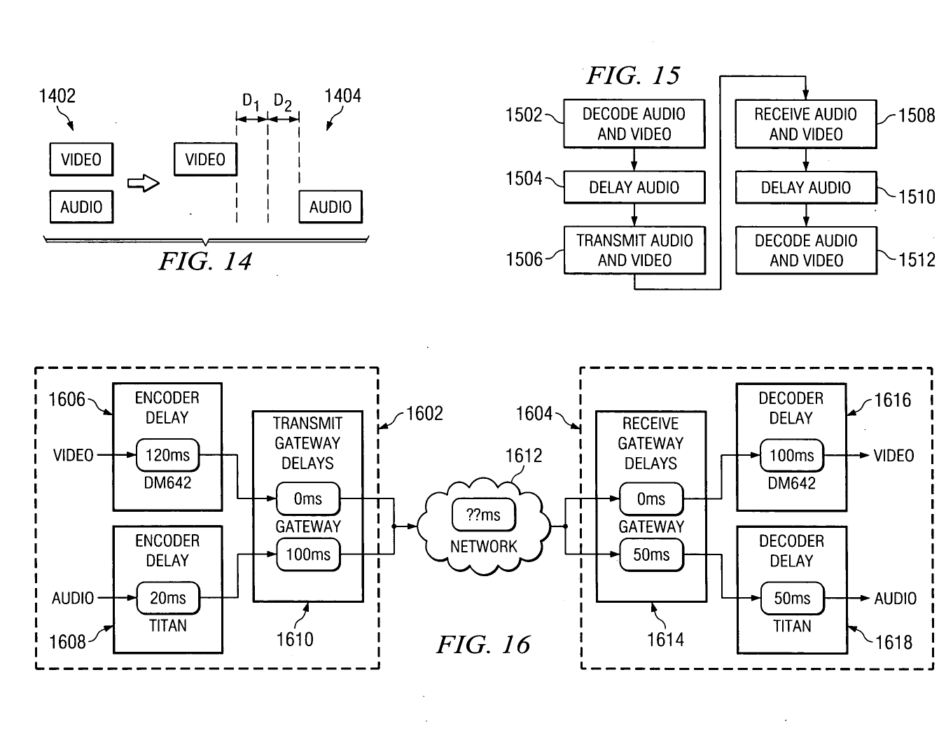

Referring now to FIG. 14, there is illustrated the problem of synchronization associated with the transmission of associated audio and video packets from a video phone at first location 1402 to a video phone at second location 1404. The video and audio encoding of the video and audio packets begins at the same time, and the packets are transmitted as the audio and video encoding are completed over an IP packet network such as the Internet. Decoding of the audio and video packets is begun upon receipt of said packets at the second location 1404. The process begins with the video and audio packets synchronized at location 1402. The packets will become unsynchronized by the time they arrive at location 1404 with the audio packets arriving for provision to a third party much sooner than the video packets. This is due to the inherent delays associated with the encoding/decoding of the video packet at both the first location 1402 and the second location 1404. The encoding of video packets at location 1402 takes longer than the encoding of audio packets. Thus, if the audio packets and video packets are transmitted as soon as they are ready, the audio packets will be transmitted prior to the video packets since the video packets will take longer to encode.

During transmission of the packets over the IP network, the assumption is that the packets sent at the same time will be grouped together as they are received and arrive at substantially the same time. However, when arriving at the second location 1404, the decoding of the video packet will again take longer than the decoding of the audio packet at the second location. Thus, the initial delay D₁ between the audio and video packets is caused by the encoding delays at the first location 1402 and the second delay D₂ is associated with the inherent decoding delay differences between the audio and video packets. Thus, a total delay of D₁+D₂ will be introduced between the audio and video packets resulting in a lack of synchronization between the audio and video packets at the receiving end.

One manner for minimizing or eliminating the lack of synchronization between the audio and video packets is illustrated in the flow chart of FIG. 15. The decoding of both the audio and video packets is begun at step 1502 with each of the associated audio and video packets being encoded in their normal fashion. However, once received at the gateway processor, the audio packets are delayed at step 1504 to an amount equal to the difference in the length of time it takes an audio packet and a video packet to be encoded. The received video packets and the delayed audio packets are transmitted at step 1506 to a second location 1404 from the first location 1402. The packets, both audio and video, are received substantially together at step 1508 at the second location 1404, and the audio packets are again delayed at step 1510 by an amount equal to the difference between the amount of time required to decode the audio packet from the amount of time to decode the video packet. The undelayed video packets and the delayed audio packets are decoded at step 1504 such that the completed decoding of associated packets will be provided at substantially the same time due to the delay introduced at the processing gateway of the receiving IP video telephone at location 1404. The introduced delay at the transmitting and receiving ends will cause the audio and video packets to be substantially synchronized.

Referring now to FIG. 16, there is more fully illustrated this process with respect to a pair of IP video telephones 1602 and 1604. The video to be encoded is input to the video processor 1606. The audio to be encoded is input to the audio processor 1608. The delay caused by the encoding is 20 milliseconds for the audio processor 1608 and 120 milliseconds for the video processor 1606. When these decoded packets are received at the gateway 1610, the audio packets are delayed by 100 milliseconds and the video packets are not delayed at all. This is due to the difference in delays associated with the encoding of the audio and video data. In this manner, associated audio and video data packets will be transmitted from the transmit gateway 1610 at substantially the same time.

The packets are transmitted over the associated IP network 1612 and statistically the packets will take the same pathway and arrive at a receive gateway 1614 at substantially the same time. The audio packets received at the receive gateway 1614 are delayed for 50 milliseconds while the video packets are not delayed at all and are passed on directly to the video decoder 1616. The provided video packets are decoded by the video decoder 1616 which takes approximately 100 milliseconds. After a delay of 50 milliseconds, the associated audio packets are forwarded to the audio decoder 1618 wherein the packets are decoded in approximately 50 milliseconds. Due to the induced delay of 50 milliseconds at the receive gateway 1614 for the audio packets, the audio packets provided from the audio decoder 1618 and the associated video packets from the video decoder 1616 will be output as associated video and audio packets at substantially the same time. This provides for a synchronized output at the IP video telephone 402.

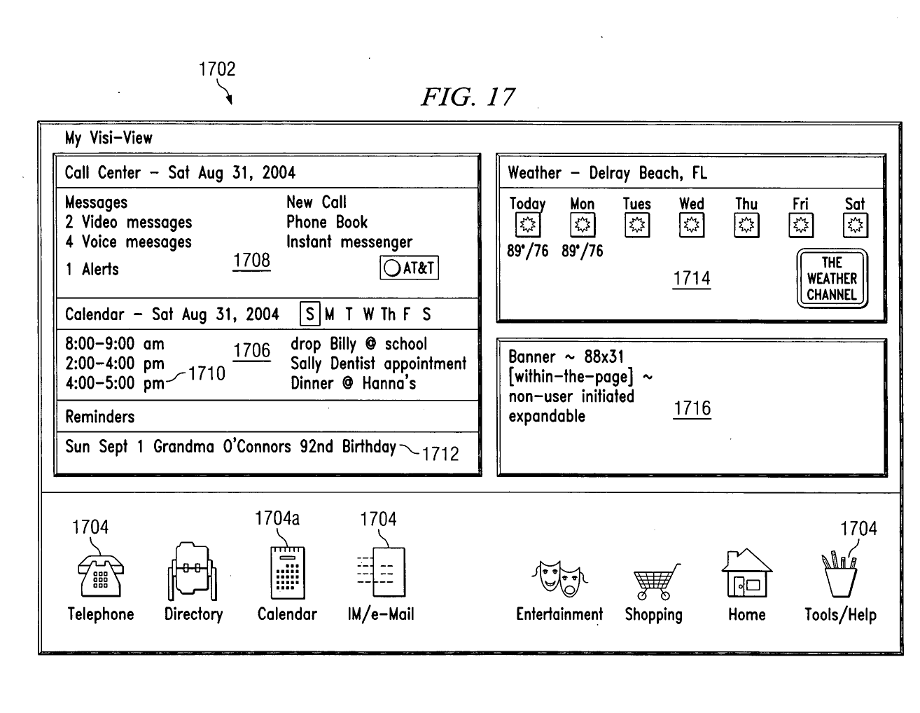

Referring now to FIG. 17, the IP video phone main display 1702 allows a user a quick and easy access to selection key applications each are which associated by a single touch button represented by a number of icons. The eight soft coded buttons 1704 that appear below the active display area 1706 correspond to specific activities or applications denoted by small icons that appear within the active display. For example, if a user selects and depresses the calendar button 1704a this will cause the IP video telephone to load and display a calendar application. The small icons on the bottom of the active display panel will vary depending upon the specific page or application that is selected by a user. As a result, each soft coded button 1704 will trigger or launch a specific and different activity or application relative to which active page or application is displayed. For example, if the user selects and depresses the button 1704a that corresponds to the calendar, this will result in loading the calendar application or load a web page that displays a user's personal calendar. When the calendar application is active, the icons that correspond to each of the buttons may differ than those as they appear in FIG. 17. The icons that would appear in the active calendar application would be relevant to the calendar application itself which will be more fully described hereinbelow.

The active display 1706 provides various information to the user. A message portion 1708 provides an indication of stored voice and video messages to the user. The calendar portion 1710 provides an abbreviated version of the user's calendar for the day and the ability to select a particular day of the week to view activities scheduled for that day. A reminders section 1712 provides various reminders that the user has programmed into the IP video telephone enabling them to be reminded of particular events or appointments. A weather display 1714 provides various information to the user on current and coming weather conditions for various days of the week. Finally, an ad window 1716 provides for the placement of banner ads that have been purchased by various advertisers that have a business relationship with the service provider of the IP video telephone. While the foregoing description describes one particular embodiment of the display associated with the IP video telephone, it will be realized by one skilled in the art that the above-described displays and the particular descriptions of the displays following herewith comprise only a single embodiment and numerous changes and alterations to the display may be made to suit a particular user and/or service provider.

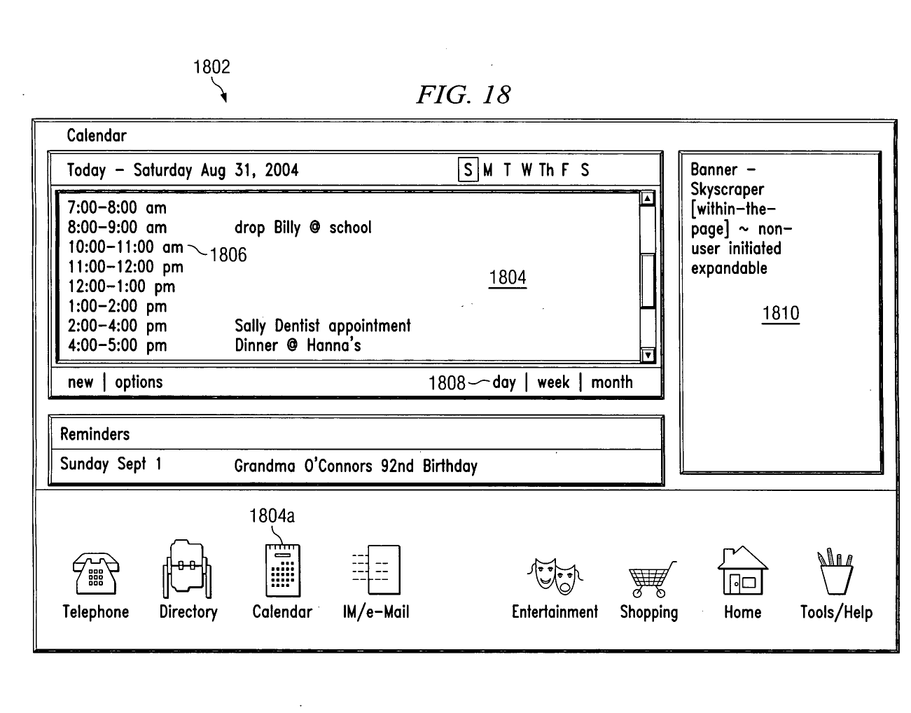

Referring now to FIG. 18, the calendar display screen 1802 provides a user with more detailed calendar information as well as enables the user to add, edit or view various individual family members' calendars. Users will have the ability to upload and download personal calendars form external sources and devices including, but not limited to, PDAs, Microsoft Outlook and Eudora. Users would also have the ability to view their personal calendars stored within the IP video telephone away from the IP video telephone as long as they have access to an Internet connection and a web browser. The active display 1804 associated with the calendar button 1704a includes a screen displaying the calendar items for today. The calendar includes options 1808 for displaying a day, week or month configuration on the calendar and an advertisement window 1810 enables banner ads to be displayed to the IP telephone user.

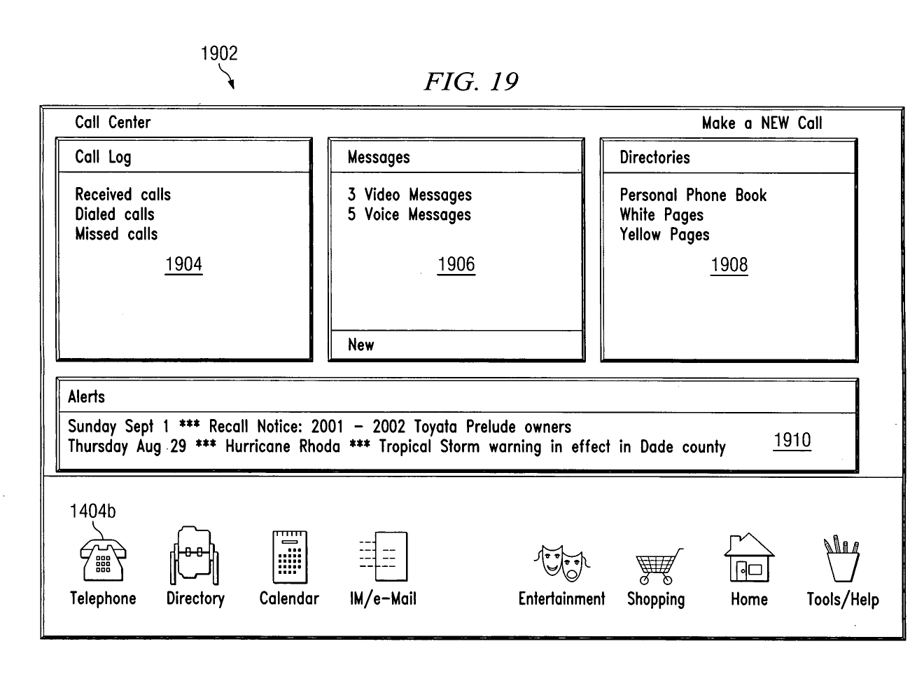

Referring now to FIG. 19, the telephone display screen 1902 is displayed responsive to pressing the telephone display button 1804b. The telephone display screen 1902 allows a user an overall view and access to call center applications including call log, audio and video messages, directories and telephone listings, alert notifications and the IP telephone's dial pad to make a telephone or video call. Text within the call log pane 1904, message pane 1906 and directory pane 1908 are hot linkable. A user is able to drill down and view more detailed information within the selected window panes by simply using a tethered stylis and touching a respective hot link. For example, if a user selects and touches “Receive Calls” hot link in the call log window pane 1904, the user will be able to review all of the received calls that have been stored within the memory of the IP video telephone.

The call log pane 1904 additionally provides information on previously dialed calls and missed calls. The messages pane 1906 provides listing of both video and voice messages that have been received and stored for a user. The directories pane 1908 provides access to various telephone directories including a personally created phone book, a white pages or a yellow pages. An alerts pane 1910 may provide either information previously indicated by the user as important to the user for which they wish to wish alerts upon, or alternatively, may be directed information pushed to the user based upon data mining analysis with respect to the user's call and/or interest activities.

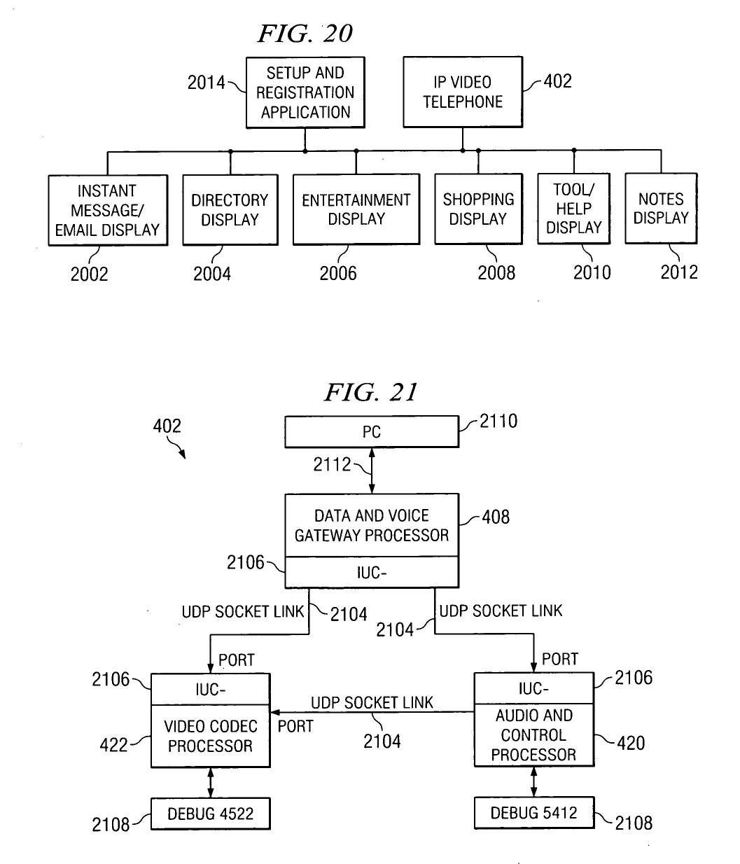

In addition to the displays described above, the IP video telephone may also include the displays illustrated in FIG. 20. The instant message/email display 2002 enables the video phone 402 to display instant messaging messages and email messages. Additionally the instant message/email display 2002 enables the creation of these kinds of messages. The directory display 2004 provides a listing of all telephone numbers that a user has stored for point and click dialing or may provide network access to publically available directories. The entertainment display 2006 displays various entertainment content that an IP telephone user has either has programmed in themselves or has been determined to be of interest to the user by a host server providing service to the IP video telephone 402. The shopping display 2008 displays various content providers that a user has indicated an interest in shopping from or displays content providers than the host server has determined a user may have an interest in shopping from the provider. The tool/help display 2010 provides an interface enabling a user to solve various problems or receive how to descriptions for the video telephone. The display 2010 includes a search screen enabling a user to search available information and a index screen with an index of available information. The notes display 2012 provides a display enabling users to leave messages or reminders to themselves or another. A note display icon may be displayed responsive to an open note. The setup and registration application display 2014 provides a user with the ability to setup and register their IP video telephone 402 with the network and a host server. Relevant information and system parameters are entered through this display.

Referring now to FIG. 21, there is illustrated a block diagram describing the manner in which the data and voice gateway processor 408, the video codec processor 422 and the audio VOIP processor 420 may carry out inter unit communications (IUC) between each of the associated devices. Communications between each of the data and voice gateway processor 408, video codec processor 422 and audio VOIP processor 420 are carried out via UDP socket link connections 2104. Communications over the UDP socket links 2104 are enabled via IUC control software 2106 stored within each of the units. The video codec processor 422 and the audio VOIP processor 420 additionally include debugging functionalities 2108 to enable the debugging of communications problems within each of these devices. The data and voice gateway processor 408 may additionally communicate with an external PC 2110 via a communications link 2112. The IUC handler 2106 on each processor uses the TCP/IP socket communications protocol as the transport layer between the various devices. The IUC handler 2106 additionally statically initializes and builds the UDP port on specific applications. The IUC handler 2106 enables command and communications between the processors to be based upon a TEXT/ASCII string. Each IUC handler 2106 converts TEXT/ASCII strings to a hexadecimal command structure. The IUC handler's 2106 other functionalities include providing a clock signal to keep processors alive, provisioning data for transportation through IUC socket connections and providing pay load data through different claims. Interdevice communications use a local area network (LAN) Ethernet transport, TCP/IP protocol, and optionally may communicate via an onboard LAN card with an external PC 2110.

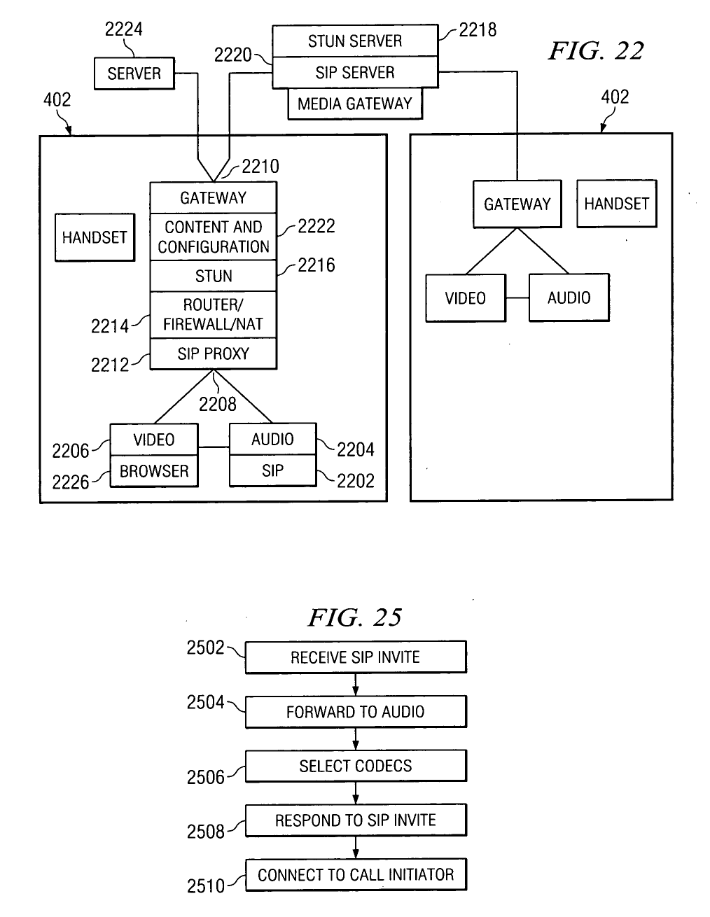

Referring now to FIG. 22, there is more fully illustrated a pair of IP video telephones 402 and the software modules associated therewith enabling call connections between a pair of IP video telephones 402 and enabling the provision of content to a display of the IP video telephone 402 via the Internet. As described previously, the video telephone 402 consists of the gateway processor 408, audio processor 422, video processor 420 and a telephone handset 104 providing a user interface with the functionalities of the video telephone 402. The audio processor 422 includes a SIP module 2202 enabling the video telephone 402 to set up calls over the Internet using a voice over IP functionality to carry out the calls. Calling between video telephones 402 is enabled via the SIP (session initiation protocol) protocol.

SIP is a signaling protocol for Internet conference, telephony, presence, event notification and instant messaging. SIP provides the necessary protocol mechanisms so that systems and proxy server can provide services such as call forwarding; callee and calling “number” delivery, where numbers can be any (preferably unique) naming scheme; personal mobility, i.e., the ability to reach a called party under a single, location independent address even when the user changes terminals; terminal type negotiation and selection wherein a caller can be given a choice how to reach the party such as via Internet telephone, mobile phone, an answering service, etc.; terminal capability negotiation; caller and callee authentication; blind and supervised call transfer; and invitations to multicast conferences. Extensions of SIP allow third party signaling such as quick to dial services, fully meshed conferences and connections to multipoint control units, as well as mixed mode and the transition between those. SIP addresses users by an email-like address and reuses some of the infrastructure of electronic mail delivery such as DNSMX records or using SMTPEXPN for address expansions. SIP addresses (URLs) can also be embedded in web pages. SIP is addressing neutral, with addresses expressed as URLs of various types such as SIP, H.323 or telephone (E.164). SIP is independent of the packet layer and only requires an unreliable datagram service, as it provides its own reliability mechanism.

The data port 2204 of the audio processor 422, the data port 2206 of the video processor 420 and the data port 2208 of the gateway processor 408 each have unique internal IP addresses associated therewith that are used only within the video telephone 402. These unique IP addresses are different from the IP address associated with the data port 2210 with which the IP video telephone 402 is connected with the external world from the gateway processor 408. In order for data packets to be transmitted between the audio processor 422 and the video processor 420 to the external IP network through the gateway processor 408. The Ethernet and SIP addresses used within the internal Ethernet network and over the external IP network must be translated. Thus, when data packets are transmitted to the gateway processor 408, the SIP proxy 2212 is responsible for converting the SIP protocol addresses from the address utilized by the audio processor 422 to the SIP protocol address used at the output of the gateway processor 408. The SIP proxy module 2212 additionally converts the address of video packets from the video processor 420 to the address of the output of the gateway processor 408. The SIP proxy 2212 additionally includes the capability for routing audio stream packets to/from the audio processor 422 and video stream packets coming to/from the video processor 420 at the same time. The SIP proxy 2212 achieves this by transmitting the video packets as a second audio stream of larger audio packets. The SIP proxy 2212 believes it is transmitting a second audio stream when in fact it is transmitting the stream of video packets from the video processor. The router/firewall/NAT 2214 is responsible for translating addresses from packets received from the audio processor 422 and the video processor 420 in the ethernet domain. The packets from the audio and video processors have the IP port addresses from the outputs of both the audio and video processors. The router/firewall/NAT 2214 converts the addresses of these output ports to the address of the output port 2210 of the gateway processor 408 at the Ethernet level.

The stun module 2216 is utilized to enable the gateway processor 408 of the video telephone 402 to determine the IP address by which the outside world views the video telephone. The stun module 2216 does this by transmitting messages to a stun server 2218 associated with the SIP server 2220 enabling call connections. The stun server 2218 transmits a response back to the stun module 2216 indicating the outside world's view of data from the IP video telephone 402.

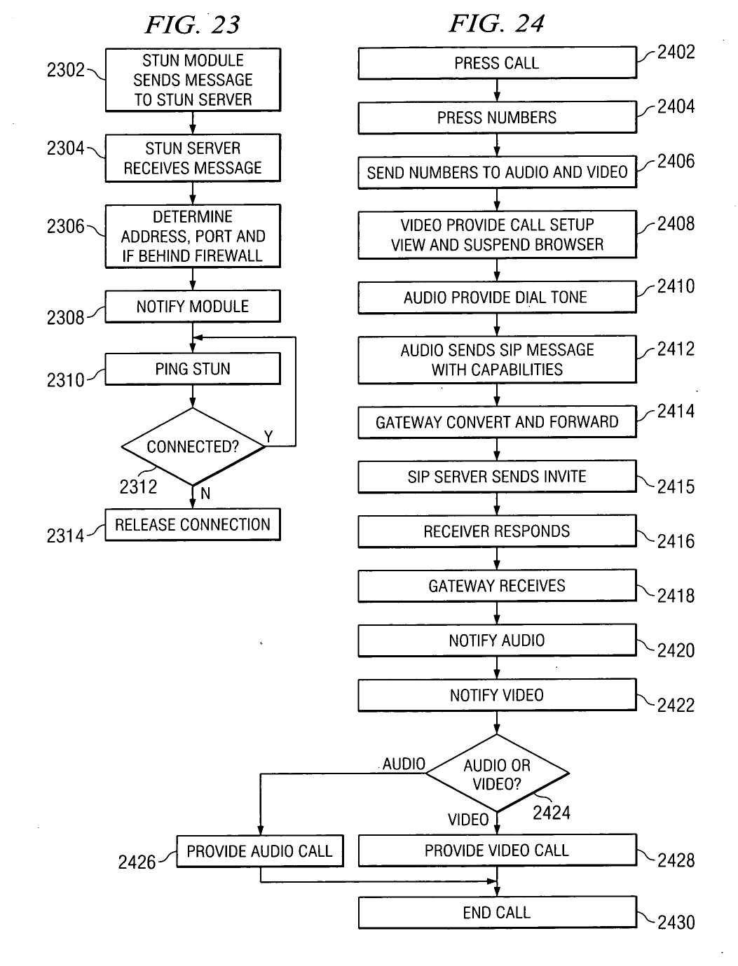

Referring now also to FIG. 23, there is more fully illustrated the manner in which the stun module 2216 is able to determine the way in which the outside world views the associated video telephone and in which the stun module 2216 provides an open port connection between the SIP server 2220 and a video telephone 402 by which an outside caller may connect to the video telephone 402. The stun module 2216 sends a message to the stun server 2218 at step 2302. The stun server 2218 receives at step 2304 the message from the stun module 2216 and determines at step 2306 the address associated with the video telephone 402 transmitting the stun server message, the port from which the stun server message is being transmitted and whether or not the data being transmitted from the video telephone is coming from behind a firewall. Responsive to this determination, the stun server 2218 notifies the stun module 2216 of its determinations at step 2308. Utilizing this information, the stun module 2216 periodically transmits messages to the stun server 2218 at step 2310 in order to maintain a connection between the video telephone 402 and the SIP server 2220. This periodic pinging to the stun server 2218 will continue as long as inquiry step 2312 determines that the video telephone is still connected to the network. Once inquiry step 2312 determines that the video telephone 402 is no longer connected, the connection is released at step 2314. The purpose for maintaining the connection between the stun server 2218 associated with the SIP server 2220 and the video telephone 402 is to enable incoming calls to be received by the video telephone. If the connection through the stun server were not maintained, the gateway processor 408 of the video telephone 402 would view an incoming message as an attempt to improperly access the gateway processor 408. By maintaining the connection between the stun module 2216 and the stun server 2218, the connection may be used to transmit incoming calls by transmitting SIP protocol messages over the connection to the gateway processor 408 of a receiving video telephone 402.

The content and configuration module 2222 enables control of the configuration of the audio processor 422 and the video processor 420. All operating parameters within these two processors are controllable through the content and configuration module 2222. One parameter the content and configuration module 2222 may set is the codec with which the audio and video processors process incoming and outgoing data packets. The audio processor may be configured to operate according to the G.711, G.722, G.720 or any other available audio codec with which the audio processor 422 may operate. Likewise, the video processor 420 may be configured to code/decode video packet data according to H.264, H.263 or other types of video codecs. In the preferred embodiment, the configuration parameters may be set within the content and configuration module 2222 from an external host server 2224. This external server may download these parameters into the content and configuration module 2222 and the content and configuration module 2222 may then download the appropriate parameters to the video processor 420 and the audio processor 422 through the internal ethernet.

The content and configuration module 2222 is also able to control the content which is displayed by the browser 2226 within the video processor 420. The browser 2226 operates as an Internet browser providing the ability for the video processor 420 to display various web page content upon the display of the video telephone 402. Content may be established within the content and configuration module 2222 either by the user of the video telephone 402 selecting display preferences or controlling browsing of the Internet through the browser 2226 using, for example, the handset 104. Alternatively, the external server 2224 may push content to the content and configuration module 2222 in order to enable external content providers to display, for example, directed advertising information on the browser 2226 of the video telephone 402. Thus, the content portion of the content and configuration module 2222 may be either controlled locally via the user of the video telephone 402 or externally via a content provider providing a server 2224 interconnected with the video telephone 402.

Referring now to FIG. 24, there is a flow diagram illustrating the manner in which a call connection may be created between a first video phone and an external video phone or non-video phone. Initially, the user presses a call button on the handset of the video telephone at step 2402. After pressing the call button, the user presses in the numbers associated with the called party at step 2404. The gateway processor 408 sends the dialed numbers at step 2406 to both the audio processor 422 and the video processor 420. Responsive to the received numbers, the video processor 420 provides at step 2408 a call setup view in the display and suspends operation of the browser 2226. The call setup view provides a visual indication to the user such as a “called number” display or “call ringing” indication when the call is ringing on the called line. Responsive to the receipt of the dialed numbers from the gateway processor 408, the audio processor 422 provides at step 2410 a dial tone indicating that an outgoing call line has been accessed. The dial tone is provided by the SIP functionalities 2202 within the audio processor 422.

The audio processor 422 sends at step 2412 a SIP message to the gateway processor 408. The SIP message includes the audio and visual codec capabilities of the calling video telephone 402. The gateway processor 408 converts the IP addresses associated with the SIP protocol and the IP addresses associated with the Ethernet protocol to the appropriate addresses using the SIP proxy 2212 and router/firewall/NAT module 2214 and forwards this information to the SIP server 2220. The SIP server 2220 generates a SIP invite at 2415 which is forwarded to the called party. The called party responds to the received SIP invite at step 2416, and the gateway processor 408 receives at step 2418 the called party's response. The appropriate address conversions are made by the router/firewall/NAT module 2214 and SIP proxy 2212 at the gateway 408 such that the audio processor 422 may be notified at step 2220 of the completion or non-completion of the call. Once the call is connected, the video processor 420 is notified at step 2422 by the audio processor 422 of the call connection. Inquiry step 2224 determines if the called party enables provision of an audio only or an audio/video call. If only audio is provided, an audio call is provided at step 2426. If an audio/video call is indicative, the video call is provided at step 2428. The call continues until the call is ended at step 2430.

If the called party is another video telephone according to the type described hereinabove, the receipt of a SIP server invite would cause the operation as illustrated in the flow chart of FIG. 25. Initially, the SIP invite is received by the gateway processor 408 at step 2502. The gateway processor 408 forwards the SIP invite at step 2504 to the audio processor 422. The audio processor 422 is able to read all of the codecs indicated within the received invite provided by the calling party and select the appropriate codecs at step 2506 for use with the call. Thus, if the video telephone 402 provides both audio and video capabilities, the video phone would select both an audio codec and a video codec for processing the call. Next, the audio processor 422 responds to the SIP invite at step 2508 indicating the codecs that will be used for completion of the call connection. This operation within the audio processor 422 is carried out by the SIP functionality 2502. Finally, the audio processor 422 and video processor 420 are able to connect with the calling party at step 2510 utilizing the selected codecs to provide a video telephone call between the calling party and the called party.

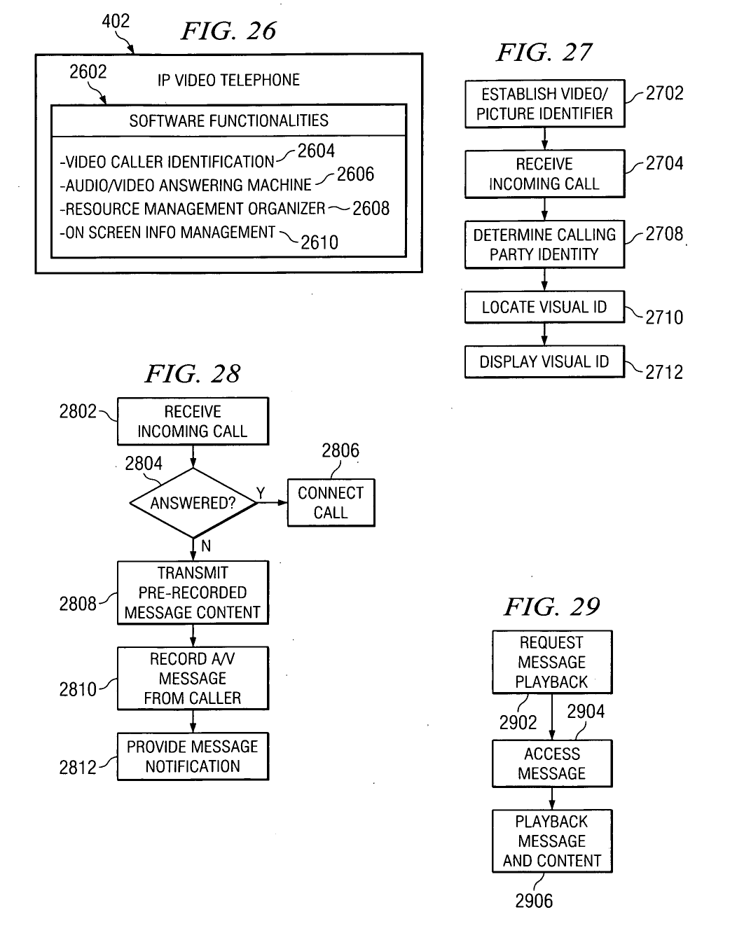

Referring now to FIG. 26, there is illustrated the IP video telephone 402 including a number of software functionalities 2602 therein. Software functionalities 2602 may be implemented within any of the memories of the IP video telephone 402. Additionally, the software functionalities 2602 would be operable within any of the gateway processor 408, the video processor 420 and the audio processor 422. In each cases, the software functionalities would utilize one or more of these processors.

A first software functionality may comprise a video caller identification module 2604. The video caller identification module 2604 enables the IP video telephone 402 to display a visual indication of the calling party on the display of the IP video telephone. This visual indication may comprise a video clip of the calling party or a digital picture of the calling party which is displayed. The visual representation of the calling party may be stored locally within the IP video telephone 402, or alternatively, may be stored in the host server interconnected with the IP video telephone 402 over the network. This visual image provided in response to the receipt of an identification from the calling party may be downloaded, scanned or otherwise input into the IP video telephone 402.

Referring now to FIG. 27, there is illustrated a flow diagram describing the operation of the video caller identification module 2604. Initially, the user of the IP video telephone establishes a video or picture identifier for a party which may call the IP video telephone 402 at step 2702. A call is received at step 2704. Responsive to the incoming call, a determination is made at step 2708 of the identity of the calling party. This information may be determined from the standard caller identification signal included in most analog telephone calls, or alternatively, may use some type of similar identifier from a call coming from a party also using an IP video telephone 402. Once the calling party's identity is determined, a visual ID for the calling party is located at step 2710. This process may be achieved by accessing a relational database including various caller identifiers and their associated visual ID that is stored either locally within the IP video telephone 402 or remotely at the host server which may be accessed by the IP video telephone 402 through the network, such as the Internet. Once the appropriate visual ID is located, the IP video telephone 402 displays the located visual ID on the display of the phone. In the case of location of the identifier at a remote host server, the video identifier is first transmitted to the IP video telephone via the network.

Referring now back to FIG. 26, an additional software functionality 2602 may comprise an audio/video answering machine 2606. The audio/visual answering 2606 machine provides the ability to record both audio and audio/video messages for the IP video telephone 402 responsive to an incoming call. The recorded audio/video message typically instructs a caller to record a message or take some other type of action. In one embodiment, in addition to the audio/visual message instructing the caller to record a message, a message including promotional material such as a commercial may be included within the message. This same type of commercial content may also be included within messages to the user of the IP video telephone 402 when the user is reviewing a message left by a caller.

Referring now to FIG. 28, there is illustrated the manner of operation of the audio/visual answering machine 2606, responsive to an incoming call. The IP video telephone 402 receives at step 2802, an incoming call responsive to a user dialing their IP video telephone number. The incoming call may come from another IP video telephone 402, or alternatively, could come from a cell phone or POTS telephone. Inquiry step 2804 determines if the incoming call is answered. If the incoming call is answered, the incoming call is connected to the IP video telephone at step 2806. If the incoming call is not answered, a prerecorded message content is transmitted to the calling party at step 2808. In a first embodiment, the pre-recorded message content is transmitted directly from the IP video telephone 402 that is being called by the calling party. In an alternative embodiment, the pre-recorded message content can be stored within a memory associated with a host server. When the message is transmitted from the host server, additional commercial content may be inserted into the transmitted pre-recorded message to provide advertising content to the calling party.

Once the pre-recorded message has been played, an audio/video message is recorded from the caller at step 2810. This assumes that the calling party has an IP video telephone 402 like the called party's IP video telephone. However, if the calling party is calling from a POTS telephone or cellular telephone without video capabilities, only an audio message may be recorded. When the message is recorded at step 2810, it may be stored locally within the IP video telephone 402 or may be stored within the host server for later retrieval. Once the message has been stored, a message notification is provided to the IP video telephone at step 2812 such that a user may be notified that they have a call message waiting. This notification may be in the form of some type of visual indicator on the display screen of the IP video telephone 402 or may comprise a blinking light on the IP video telephone 402 or may even comprise an audio indication provided from the IP video telephone 402, or any other type of notifier.

When a user of the IP video telephone 402 notices the message notification, the user may review stored messages as described in the flow diagram of FIG. 29. Initially, the user requests at step 2902, message playback by entering a command sequence involving pressing one or more buttons or other input methods. The command sequence initiates the playback of the audio/visual message. The IP video telephone accesses the stored message at step 2904 either locally within the IP video telephone 402 or by downloading the message from the host server via the IP network. The user has the ability to play back the message and any associated content at step 2906. The user may control playback of the message using the key button interface of the IP video telephone by pressing various numbers or associated letters on the IP video telephone to pause, restart, playback, or any other type of call answering machine control functionality that may be needed. If the audio/visual message has been transmitted from the host server, the host server may insert into the message additional commercial content to provide directed advertising to the reviewer of the recorded audio/visual message. Since the server is aware of the presence of messages, the host server may collect data regarding the number of times a promotional message has been played by a consumer. This enables advertisers to monitor the saturation of their message with exact real time accuracy.

Referring now back to FIG. 26, the software functionalities 2602 may further include a resource management organizer 2608. The resource management organizer 2608 receives input from a user via the IP video telephone 402. The integrated resource manager 2608 may also receive input from a content provider or the host server via the attached network, such as the Internet. The resource management organizer 2608 enables a user to manage an address book, calendar, to-do list, or other forms of resource management. The resource management organizer 2608 supports the use of video and audio files to record entries into the resource management database. Using the resource management organizer 2608, the user is able to navigate and operate the control pages described previously with respect to FIGS. 17-20.

An additional software functionality 2602 comprises an on-screen information management system 2610. The on-screen information management function 2610 provides a visual menu to a user of the IP video telephone 402 on the display thereof. The visual menu includes various content and offers the user a selection of content or other options regarding programming, scheduling or management of the content. The user is able to select content using a touch screen display or manipulating manual inputs associated with the IP video telephone 402. The on-screen information management system 2610 would operate with the browser functionality of the video processor 420 in order to provide various content to the user of the IP video telephone 402 via the network.

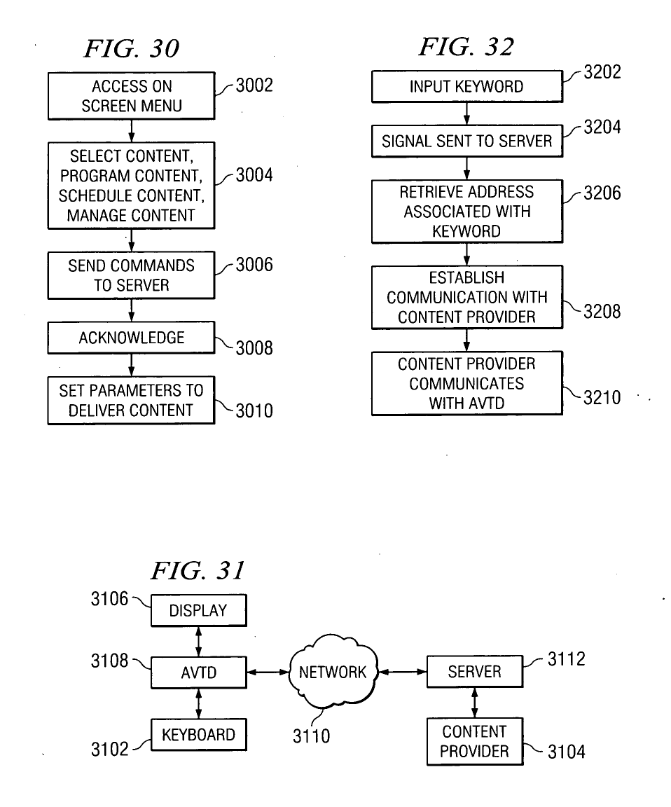

Referring now to FIG. 30, there is illustrated a flow diagram describing the process by which a user may control the content provided to the IP video telephone 402 using the on-screen management system 2610. Initially, at step 3002, the user accesses the on-screen menu. This will display to the user all of the possible content choices that are available to the user through the on-screen menu. Next, through the on-screen menu, the user is able to perform a number of operations, such as selecting content, programming content, scheduling content to be played at specific times, or managing content as presently stored or desired to be stored within the IP video telephone at step 3004. Responsive to the content operation provided by the user, various commands are generated by the on-screen information management system 2610 at step 3006 and transmitted to the host server through the network, such as the Internet. Responsive to the received commands, the host server generates an acknowledgment at step 3008 back to the IP video telephone 402. The host server establishes the parameters necessary to deliver the content as instructed responsive to the commands from the IP video telephone 402 at step 3010.

Referring now to FIG. 31, there is illustrated an IP video telephone 402 having an integrated incentive promotions function. The integrated incentive promotion function may be integrated within the operating software of the IP video telephone 402. The IP video telephone 402 would receive transmissions from a content provider 3104 or the host server 3110 asking the user of the IP video telephones to provide certain inputs such as scanning information into the IP video telephone 402 using the associated scanner 3106 or manually entering information into the IP video telephone 402 through the user interface. Responsive to these inputs to the requests provided by the host server 3110 or content provider 3104, the integrated incentive promotion function provides various incentives to the user, such as entering the user into a contest of a particular content provider 3104. This would involve the incentive promotions manager sending a particular code back to the content provider 3104 through the network 3112 responsive to the user providing the desired input. Additionally, the user of the IP video telephone 402 could be provided with some type of coupon that could be printed upon a printer 3114 of the IP video telephone 402. The coupon may be used for some type of discount for the purchase of items related to the incentive promotion to which the user responded. The coupon could be used in a normal brick and mortar store or, alternatively, could have a code thereon which may be entered by a user to obtain the discount in an electronic commerce transaction.

Referring now to FIG. 32, there is illustrated a flow chart of an integrated interactive promotion associated with the IP video telephone 402. When the IP video telephone 402 is functioning, visual promotional content is displayed on the display of the IP video telephone 402 at step 3202. The visual promotional content includes a request for interaction by a user of the IP video telephone 402 at step 3204. Inquiry step 3206 determines if some type of user input has been received. If not, control passes to step 3210 and additional content is displayed to the user. If inquiry step 3206 determines that user input has been received, control passes to step 3208 wherein the IP video telephone is given further access to promotional material by establishing a two-way audio/visual communication with a content provider 2404, displaying further media content or a mixture of these two processes. Responsive to these further accesses, inquiry step 3206 determines if additional input is received from a user and if not, normal content can again be shown at step 3210. The interactive process may continue between step 3208 and 3206 until all available content has been provided to the user or until the user is providing no more interactive input to the IP video telephone 402.

It will be appreciated by those skilled in The art having The benefit of this disclosure that this invention provides a broadband information appliance. It should be understood that The drawings and detailed description herein are to be regarded in an illustrative rather than a restrictive manner, and are not intended to limit The invention to The particular forms and examples disclosed. On The contrary, The invention includes any further modifications, changes, rearrangements, substitutions, alternatives, design choices, and embodiments apparent to those of ordinary skill in The art, without departing from The spirit and scope of this invention, as defined by The following claims. Thus, it is intended that The following claims be interpreted to embrace all such further modifications, changes, rearrangements, substitutions, alternatives, design choices, and embodiments.

1. An IP video telephone, comprising:
a video display for displaying a received video signal;
a speaker for playing a received audio signal;
a plurality of processors for processing the received audio and video signals and transmitted audio and video signals, wherein the plurality of processors are each located on a same processing board;
an ethernet network for interconnecting the plurality of processors; and
an integrated device associated with at least one of the plurality processors.

2. The IP video telephone of claim 1, wherein the integrated device is wirelessly connected to the IP video telephone.

3. The IP video telephone of claim 1, wherein the integrated device comprises a digital jukebox.

4. The IP video telephone of claim 1, wherein the integrated device comprises a VOIP multimedia terminal adaptor.

5. The IP video telephone of claim 1, wherein the integrated device comprises a video camera.

6. The IP video telephone of claim 1, wherein the integrated device comprises a network radio receiver.

7. The IP video telephone of claim 1, wherein the integrated device comprises a digital camera.

8. The IP video telephone of claim 1, wherein the integrated device comprises a coupon server.

9. The IP video telephone of claim 1, wherein the integrated device comprises an interchangeable video display.

10. The IP video telephone of claim 9, further comprising:
a video display holder for physically holding the interchangeable video display; and
a video display interface connected to the video display holder for electrically connecting the interchangeable video display to the IP video telephone.

11. The IP video telephone of claim 1, wherein the integrated device comprises a scanner.

12. The IP video telephone of claim 1, wherein the integrated device comprises a ticket server.

13. The IP video telephone of claim 1, wherein the integrated device comprises an RFID reader.

14. The IP video telephone of claim 1, wherein the plurality of processors are configured to determine an identification of a calling number and to display a video indication associated with the identified calling party.

15. The IP video telephone of claim 1, wherein the plurality of processors are configured to play an audio visual message in response to an unanswered incoming call and recording a message from an incoming calling party.

16. An IP video telephone, comprising:
a video display for displaying a received video signal;
a speaker for playing a received audio signal;
a gateway processor for connecting the IP video telephone to an external IP network to receive the received video signal and the received audio signal, wherein the gateway processor is configured to convert a first address of a SIP packet to a second address and to convert a third address of a ethernet packet to a fourth address;
a video processor for processing the received video signal;
an audio processor for processing the received audio signal;
an ethernet network for interconnecting the gateway processor, the video processor and the audio processor within the IP video telephone;
wherein the gateway processor, the video processor and the audio processor are each located on a same processing board; and
an integrated device associated with at least one of the plurality processors.

17. The IP video telephone of claim 16, wherein the integrated device is wirelessly connected to the IP video telephone.
